(19) United States
(12) Patent Application Publication
(10) Pub. No.: US 2020/0021807 A1
(43) Pub. Date: Jan. 16, 2020

(54) IMAGE DECODING METHOD AND APPARATUS USING INTRA PREDICTION INFORMATION IN IMAGE CODING SYSTEM

(71) Applicant: LG ELECTRONICS INC., Seoul (KR)

(72) Inventors: Seunghwan Kim, Seoul (KR); Ling Li, Seoul (KR); Jaehyun Lim, Seoul (KR)

(21) Appl. No.: 16/509,745

(22) Filed: Jul. 12, 2019

Related U.S. Application Data
(60) Provisional application No. 62/698,008, filed on Jul. 13, 2018.

(51) Int. Cl. H04N 19/11; H04N 19/593; H04N 19/176

(52) U.S. Cl. CPC H04N 19/11; H04N 19/176; H04N 19/593

(57) ABSTRACT

Provided is a decoding method performed by a decoding apparatus, which includes: obtaining intra prediction information of the current block through a bitstream; deriving an intra prediction mode of the current block based on remaining intra prediction mode information; deriving a prediction sample of the current block based on the intra prediction mode; and deriving a reconstructed picture based on the prediction sample, in which the intra prediction information includes the remaining intra prediction mode information, and the remaining intra prediction mode information is coded through a truncated binary (TB) binarization process.

### CROSS-REFERENCE TO RELATED APPLICATIONS

Pursuant to 35 U.S.C. § 119 (e), this application claims the benefit of U.S. Provisional Application No. 62/698,008, filed on Jul. 13, 2018, the contents of which are all hereby incorporated by reference herein in their entirety.

### BACKGROUND OF THE DISCLOSURE

### Field of the Disclosure

The present disclosure relates to wireless communication and, more particularly, to a method and apparatus for coordinating inter-cell interference in a wireless communication system.

### Related Art

Demand for high-resolution, high-quality images such as HD (High Definition) images and UHD (Ultra High Definition) images has been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY

The present disclosure provides a method and an apparatus for increasing video coding efficiency.

The present disclosure also provides a method and an apparatus for coding intra prediction information.

The present disclosure also provides a method and an apparatus for coding information indicating an intra prediction mode of a current block among remaining intra prediction modes.

In an aspect, a video decoding method performed by a decoding apparatus is provided. The method includes: obtaining intra prediction information of the current block through a bitstream; deriving an intra prediction mode of the current block based on remaining intra prediction mode information; deriving a prediction sample of the current block based on the intra prediction mode; and deriving a reconstructed picture based on the prediction sample, in which the intra prediction information includes the remaining intra prediction mode information, and the remaining intra prediction mode information is coded through a truncated binary (TB) binarization process.

In another aspect, a decoding apparatus performing video decoding is provided. The decoding apparatus includes: an entropy decoding unit obtaining intra prediction information of the current block through a bitstream; and a prediction unit deriving an intra prediction mode of the current block based on remaining intra prediction mode information; deriving a prediction sample of the current block based on the intra prediction mode; and deriving a reconstructed picture based on the prediction sample, in which the intra prediction information includes the remaining intra prediction mode information, and the remaining intra prediction mode information is coded through a truncated binary (TB) binarization process.

In yet another aspect, a video encoding method performed by an encoding apparatus is provided. The method includes: constructing a Most Probable Mode (MPM) list of a current block based on a neighboring block of the current block; determining an intra prediction mode of the current block, wherein the intra prediction mode of the current block is one of remaining intra prediction modes; generating a prediction sample of the current block based on the intra prediction mode; and encoding video information including intra prediction information for the current block, in which the remaining intra prediction modes are intra prediction modes except for MPM candidates included in the MPM list from all intra prediction modes, the intra prediction information includes remaining intra prediction mode information, the remaining intra prediction mode information indicates the intra prediction mode of the current block among the remaining intra prediction modes, and the remaining intra prediction mode information is coded through a truncated binary (TB) binarization process.

In still yet another aspect, a video encoding apparatus is provided. The encoding apparatus includes: a prediction unit constructing a Most Probable Mode (MPM) list of a current block based on a neighboring block of the current block, determining an intra prediction mode of the current block, in which the intra prediction mode of the current block is one of remaining intra prediction modes, and generating a prediction sample of the current block based on the intra prediction mode; and an entropy encoding unit encoding video information including intra prediction information for the current block, in which the remaining intra prediction modes are intra prediction modes except for MPM candidates included in the MPM list from all intra prediction modes, the intra prediction information includes remaining intra prediction mode information, the remaining intra prediction mode information indicates the intra prediction mode of the current block among the remaining intra prediction modes, and the remaining intra prediction mode information is coded through a truncated binary (TB) binarization process.

### BRIEF DESCRIPTION OF THE DRAWINGS

FIG. 1 is a schematic diagram illustrating a configuration of a video encoding device to which the present disclosure is applicable.

FIG. 2 illustrates an example of an image encoding method performed by a video encoding device.

FIG. 3 is a schematic diagram illustrating a configuration of a video decoding device to which the present disclosure is applicable.

FIG. 4 illustrates an example of an image decoding method performed by a decoding device.

FIG. 5 illustrates an example of an image encoding method based on intra prediction.

FIG. 6 illustrates an example of an image decoding method based on intra prediction.

FIG. 7 illustrates intra-directional modes of 65 prediction directions.

FIG. 8 illustrates an example of performing an intra prediction.

FIG. 9 illustrates the neighboring samples used for an intra prediction of the current block.

FIG. 10 illustrates neighboring blocks of the current block.

FIG. 11 exemplarily illustrates a method for coding information for representing n intra prediction modes including MPM candidates and remaining intra prediction modes.

FIG. 12 exemplarily illustrates a method for coding information for representing n intra prediction modes including MPM candidates and remaining intra prediction modes.

FIG. 13 schematically illustrates a video encoding method by an encoding apparatus according to the present disclosure.

FIG. 14 schematically illustrates an encoding apparatus performing a video encoding method according to the present disclosure.

FIG. 15 schematically illustrates a video decoding method by a decoding apparatus according to the present disclosure.

FIG. 16 schematically illustrates a decoding apparatus performing a video decoding method according to the present disclosure.

FIG. 17 exemplarily illustrates a structure diagram of a content streaming system to which the present disclosure is applied.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments, but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the disclosure without departing from the concept of the disclosure.

Hereinafter, embodiments of the present disclosure will be described in detail with reference to the accompanying drawings. In addition, like reference numerals are used to indicate like elements throughout the drawings, and the same descriptions on the like elements will be omitted.

Meanwhile, the present disclosure relates to video/image coding. For example, the method/embodiment disclosed in the present disclosure may be applied to a method disclosed in versatile video coding (VVC) standard, essential Video Coding (EVC) standard, AOMedia Video 1 (AV1) standard, 2nd generation of audio video coding standard (AVS2) or next generation video/image coding standard (e.g., H.267, H.268, etc.).

In the present specification, generally a picture means a unit representing an image at a specific time, a slice is a unit constituting a part of the picture. One picture may be composed of plural slices, and the terms of a picture and a slice may be mixed with each other as occasion demands.

A pixel or a pel may mean a minimum unit constituting one picture (or image). Further, a “sample” may be used as a term corresponding to a pixel. The sample may generally represent a pixel or a value of a pixel, may represent only a pixel (a pixel value) of a luma component, and may represent only a pixel (a pixel value) of a chroma component.

A unit indicates a basic unit of image processing. The unit may include at least one of a specific area and information related to the area. Optionally, the unit may be mixed with terms such as a block, an area, or the like. In a typical case, an M×N block may represent a set of samples or transform coefficients arranged in M columns and N rows.

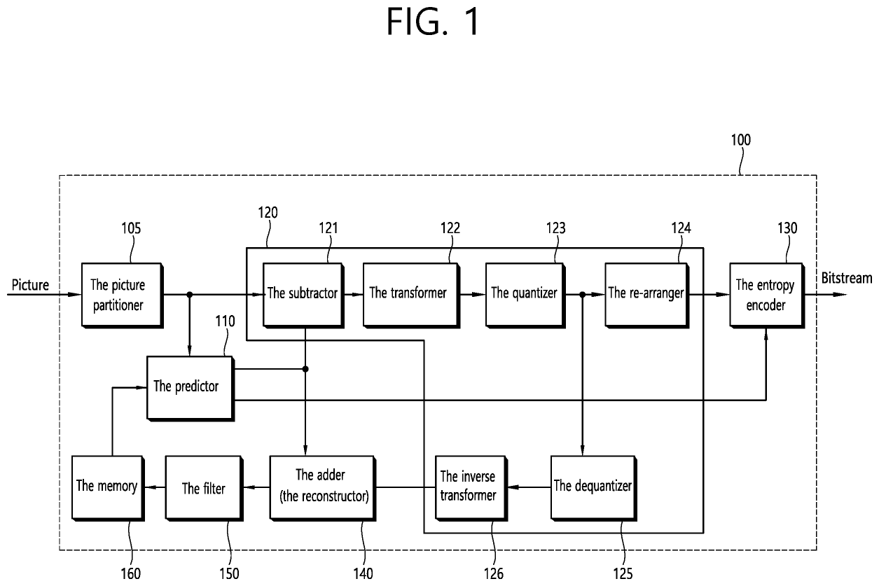

FIG. 1 is a schematic diagram illustrating a configuration of a video encoding device to which the present disclosure is applicable.

Referring to FIG. 1, a video encoding device 100 may include a picture partitioner 105, a predictor 110, a residual processor 120, an entropy encoder 130, an adder 140, a filter 150, and a memory 160. The residual processor 120 may include a subtractor 121, a transformer 122, a quantizer 123, a re-arranger 124, a dequantizer 125, an inverse transformer 126.

The picture partitioner 105 may split an input picture into at least one processing unit.

In an example, the processing unit may be referred to as a coding unit (CU). In this case, the coding unit may be recursively split from the largest coding unit (LCU) according to a quad-tree binary-tree (QTBT) structure. For example, one coding unit may be split into a plurality of coding units of a deeper depth based on a quadtree structure and/or a binary tree structure. In this case, for example, the quad tree structure may be first applied and the binary tree structure may be applied later. Alternatively, the binary tree structure may be applied first. The coding procedure according to the present disclosure may be performed based on a final coding unit which is not split any further. In this case, the largest coding unit may be used as the final coding unit based on coding efficiency, or the like, depending on image characteristics, or the coding unit may be recursively split into coding units of a lower depth as necessary and a coding unit having an optimal size may be used as the final coding unit. Here, the coding procedure may include a procedure such as prediction, transformation, and reconstruction, which will be described later.

In another example, the processing unit may include a coding unit (CU) prediction unit (PU), or a transform unit (TU). The coding unit may be split from the largest coding unit (LCU) into coding units of a deeper depth according to the quad tree structure. In this case, the largest coding unit may be directly used as the final coding unit based on the coding efficiency, or the like, depending on the image characteristics, or the coding unit may be recursively split into coding units of a deeper depth as necessary and a coding unit having an optimal size may be used as a final coding unit. When the smallest coding unit (SCU) is set, the coding unit may not be split into coding units smaller than the smallest coding unit. Here, the final coding unit refers to a coding unit which is partitioned or split to a prediction unit or a transform unit. The prediction unit is a unit which is partitioned from a coding unit, and may be a unit of sample prediction. Here, the prediction unit may be divided into sub-blocks. The transform unit may be divided from the coding unit according to the quad-tree structure and may be a unit for deriving a transform coefficient and/or a unit for deriving a residual signal from the transform coefficient. Hereinafter, the coding unit may be referred to as a coding block (CB), the prediction unit may be referred to as a prediction block (PB), and the transform unit may be referred to as a transform block (TB). The prediction block or prediction unit may refer to a specific area in the form of a block in a picture and include an array of prediction samples. Also, the transform block or transform unit may refer to a specific area in the form of a block in a picture and include the transform coefficient or an array of residual samples.

The predictor 110 may perform prediction on a processing target block (hereinafter, a current block), and may generate a predicted block including prediction samples for the current block. A unit of prediction performed in the predictor 110 may be a coding block, or may be a transform block, or may be a prediction block.

The predictor 110 may determine whether intra-prediction is applied or inter-prediction is applied to the current block. For example, the predictor 110 may determine whether the intra-prediction or the inter-prediction is applied in unit of CU.

In case of the intra-prediction, the predictor 110 may derive a prediction sample for the current block based on a reference sample outside the current block in a picture to which the current block belongs (hereinafter, a current picture). In this case, the predictor 110 may derive the prediction sample based on an average or interpolation of neighboring reference samples of the current block (case (i)), or may derive the prediction sample based on a reference sample existing in a specific (prediction) direction as to a prediction sample among the neighboring reference samples of the current block (case (ii)). The case (i) may be called a non-directional mode or a non-angular mode, and the case (ii) may be called a directional mode or an angular mode. In the intra-prediction, prediction modes may include as an example 33 directional modes and at least two non-directional modes. The non-directional modes may include DC mode and planar mode. The predictor 110 may determine the prediction mode to be applied to the current block by using the prediction mode applied to the neighboring block.

In case of the inter-prediction, the predictor 110 may derive the prediction sample for the current block based on a sample specified by a motion vector on a reference picture. The predictor 110 may derive the prediction sample for the current block by applying any one of a skip mode, a merge mode, and a motion vector prediction (MVP) mode. In case of the skip mode and the merge mode, the predictor 110 may use motion information of the neighboring block as motion information of the current block. In case of the skip mode, unlike in the merge mode, a difference (residual) between the prediction sample and an original sample is not transmitted. In case of the MVP mode, a motion vector of the neighboring block is used as a motion vector predictor and thus is used as a motion vector predictor of the current block to derive a motion vector of the current block.

In case of the inter-prediction, the neighboring block may include a spatial neighboring block existing in the current picture and a temporal neighboring block existing in the reference picture. The reference picture including the temporal neighboring block may also be called a collocated picture (colPic). Motion information may include the motion vector and a reference picture index. Information such as prediction mode information and motion information may be (entropy) encoded, and then output as a form of a bitstream.

When motion information of a temporal neighboring block is used in the skip mode and the merge mode, a highest picture in a reference picture list may be used as a reference picture. Reference pictures included in the reference picture list may be aligned based on a picture order count (POC) difference between a current picture and a corresponding reference picture. A POC corresponds to a display order and can be discriminated from a coding order.

The subtractor 121 generates a residual sample which is a difference between an original sample and a prediction sample. If the skip mode is applied, the residual sample may not be generated as described above.

The transformer 122 transforms residual samples in units of a transform block to generate a transform coefficient. The transformer 122 may perform transformation based on the size of a corresponding transform block and a prediction mode applied to a coding block or prediction block spatially overlapping with the transform block. For example, residual samples can be transformed using discrete sine transform (DST) transform kernel if intra-prediction is applied to the coding block or the prediction block overlapping with the transform block and the transform block is a 4×4 residual array and is transformed using discrete cosine transform (DCT) transform kernel in other cases.

The quantizer 123 may quantize the transform coefficients to generate quantized transform coefficients.

The re-arranger 124 rearranges quantized transform coefficients. The re-arranger 124 may rearrange the quantized transform coefficients in the form of a block into a one-dimensional vector through a coefficient scanning method. Although the re-arranger 124 is described as a separate component, the re-arranger 124 may be a part of the quantizer 123.

The entropy encoder 130 may perform entropy-encoding on the quantized transform coefficients. The entropy encoding may include an encoding method, for example, an exponential Golomb, a context-adaptive variable length coding (CAVLC), a context-adaptive binary arithmetic coding (CABAC), or the like. The entropy encoder 130 may perform encoding together or separately on information (e.g., a syntax element value or the like) required for video reconstruction in addition to the quantized transform coefficients. The entropy-encoded information may be transmitted or stored in unit of a network abstraction layer (NAL) in a bitstream form.

The dequantizer 125 dequantizes values (transform coefficients) quantized by the quantizer 123 and the inverse transformer 126 inversely transforms values dequantized by the dequantizer 125 to generate a residual sample.

The adder 140 adds a residual sample to a prediction sample to reconstruct a picture. The residual sample may be added to the prediction sample in units of a block to generate a reconstructed block. Although the adder 140 is described as a separate component, the adder 140 may be a part of the predictor 110. Meanwhile, the adder 140 may be referred to as a reconstructor or reconstructed block generator.

The filter 150 may apply deblocking filtering and/or a sample adaptive offset to the reconstructed picture. Artifacts at a block boundary in the reconstructed picture or distortion in quantization can be corrected through deblocking filtering and/or sample adaptive offset. Sample adaptive offset may be applied in units of a sample after deblocking filtering is completed. The filter 150 may apply an adaptive loop filter (ALF) to the reconstructed picture. The ALF may be applied to the reconstructed picture to which deblocking filtering and/or sample adaptive offset has been applied.

The memory 160 may store a reconstructed picture (decoded picture) or information necessary for encoding/decoding. Here, the reconstructed picture may be the reconstructed picture filtered by the filter 150. The stored reconstructed picture may be used as a reference picture for (inter) prediction of other pictures. For example, the memory 160 may store (reference) pictures used for inter-prediction. Here, pictures used for inter-prediction may be designated according to a reference picture set or a reference picture list.

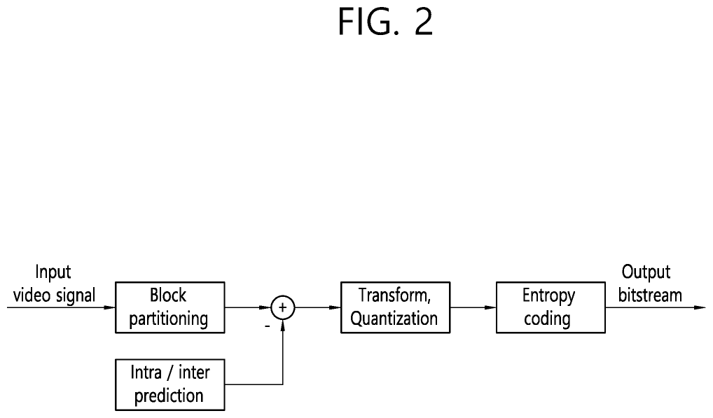

FIG. 2 illustrates an example of an image encoding method performed by a video encoding device. Referring to FIG. 2, the image encoding method may include the process of block partitioning, intra/inter prediction, transform, quantization and entropy encoding. For example, a current picture may be partitioned into a plurality of blocks, a prediction block of the current block may be generated through the intra/inter prediction, and a residual block of the current block may be generated through a subtraction between an input block of the current block and the prediction block. Later, through a transform for the residual block, a coefficient block, that is, transform coefficients of the current block may be generated. The transform coefficients may be quantized and entropy-encoded and stored in a bitstream.

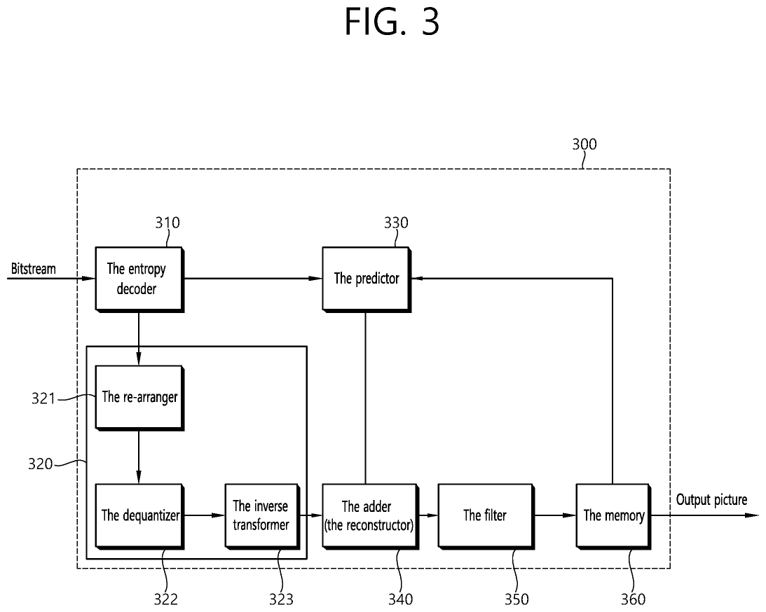

FIG. 3 is a schematic diagram illustrating a configuration of a video decoding device to which the present disclosure is applicable.

Referring to FIG. 3, a video decoding device 300 may include an entropy decoder 310, a residual processor 320, a predictor 330, an adder 340, a filter 350, and a memory 360. The residual processor 320 may include a re-arranger 321, a dequantizer 322, an inverse transformer 323.

When a bitstream including video information is input, the video decoding device 300 may reconstruct a video in association with a process by which video information is processed in the video encoding device.

For example, the video decoding device 300 may perform video decoding using a processing unit applied in the video encoding device. Thus, the processing unit block of video decoding may be, for example, a coding unit and, in another example, a coding unit, a prediction unit or a transform unit. The coding unit may be split from the largest coding unit according to the quad tree structure and/or the binary tree structure.

A prediction unit and a transform unit may be further used in some cases, and in this case, the prediction block is a block derived or partitioned from the coding unit and may be a unit of sample prediction. Here, the prediction unit may be divided into sub-blocks. The transform unit may be split from the coding unit according to the quad tree structure and may be a unit that derives a transform coefficient or a unit that derives a residual signal from the transform coefficient.

The entropy decoder 310 may parse the bitstream to output information required for video reconstruction or picture reconstruction. For example, the entropy decoder 310 may decode information in the bitstream based on a coding method such as exponential Golomb encoding, CAVLC, CABAC, or the like, and may output a value of a syntax element required for video reconstruction and a quantized value of a transform coefficient regarding a residual.

More specifically, a CABAC entropy decoding method can receive a bin corresponding to each syntax element in a bitstream, determine a context model using decoding target syntax element information and decoding information of neighboring and decoding target blocks or information of amabol/bin decoded in a previous step, predict bin generation probability according to the determined context model and perform arithmetic decoding of the bin to generate a symbol corresponding to each syntax element value. Here, the CABAC entropy decoding method can update the context model using information of a symbol/bin decoded for a context model of the next symbol/bin after determination of the context model.

Information about prediction among information decoded in the entropy decoder 310 may be provided to the predictor 330 and residual values, that is, quantized transform coefficients, on which entropy decoding has been performed by the entropy decoder 310 may be input to the re-arranger 321.

The re-arranger 321 may rearrange the quantized transform coefficients into a two-dimensional block form. The re-arranger 321 may perform rearrangement corresponding to coefficient scanning performed by the encoding device. Although the re-arranger 321 is described as a separate component, the re-arranger 321 may be a part of the dequantizer 322.

The dequantizer 322 may de-quantize the quantized transform coefficients based on a (de)quantization parameter to output a transform coefficient. In this case, information for deriving a quantization parameter may be signaled from the encoding device.

The inverse transformer 323 may inverse-transform the transform coefficients to derive residual samples.

The predictor 330 may perform prediction on a current block, and may generate a predicted block including prediction samples for the current block. A unit of prediction performed in the predictor 330 may be a coding block or may be a transform block or may be a prediction block.

The predictor 330 may determine whether to apply intra-prediction or inter-prediction based on information on a prediction. In this case, a unit for determining which one will be used between the intra-prediction and the inter-prediction may be different from a unit for generating a prediction sample. In addition, a unit for generating the prediction sample may also be different in the inter-prediction and the intra-prediction. For example, which one will be applied between the inter-prediction and the intra-prediction may be determined in unit of CU. Further, for example, in the inter-prediction, the prediction sample may be generated by determining the prediction mode in unit of PU, and in the intra-prediction, the prediction sample may be generated in unit of TU by determining the prediction mode in unit of PU.

In case of the intra-prediction, the predictor 330 may derive a prediction sample for a current block based on a neighboring reference sample in a current picture. The predictor 330 may derive the prediction sample for the current block by applying a directional mode or a non-directional mode based on the neighboring reference sample of the current block. In this case, a prediction mode to be applied to the current block may be determined by using an intra-prediction mode of a neighboring block.

In the case of inter-prediction, the predictor 330 may derive a prediction sample for a current block based on a sample specified in a reference picture according to a motion vector. The predictor 330 may derive the prediction sample for the current block using one of the skip mode, the merge mode and the MVP mode. Here, motion information required for inter-prediction of the current block provided by the video encoding device, for example, a motion vector and information about a reference picture index may be acquired or derived based on the information about prediction.

In the skip mode and the merge mode, motion information of a neighboring block may be used as motion information of the current block. Here, the neighboring block may include a spatial neighboring block and a temporal neighboring block.

The predictor 330 may construct a merge candidate list using motion information of available neighboring blocks and use information indicated by a merge index on the merge candidate list as a motion vector of the current block. The merge index may be signaled by the encoding device. Motion information may include a motion vector and a reference picture. When motion information of a temporal neighboring block is used in the skip mode and the merge mode, a highest picture in a reference picture list may be used as a reference picture.

In the case of the skip mode, a difference (residual) between a prediction sample and an original sample is not transmitted, distinguished from the merge mode.

In the case of the MVP mode, the motion vector of the current block may be derived using a motion vector of a neighboring block as a motion vector predictor. Here, the neighboring block may include a spatial neighboring block and a temporal neighboring block.

When the merge mode is applied, for example, a merge candidate list can be generated using a motion vector of a reconstructed spatial neighboring block and/or a motion vector corresponding to a Col block which is a temporal neighboring block. A motion vector of a candidate block selected from the merge candidate list is used as the motion vector of the current block in the merge mode. The aforementioned information about prediction may include a merge index indicating a candidate block having the best motion vector selected from candidate blocks included in the merge candidate list. Here, the predictor 330 may derive the motion vector of the current block using the merge index.

When the MVP (Motion vector Prediction) mode is applied as another example, a motion vector predictor candidate list may be generated using a motion vector of a reconstructed spatial neighboring block and/or a motion vector corresponding to a Col block which is a temporal neighboring block. That is, the motion vector of the reconstructed spatial neighboring block and/or the motion vector corresponding to the Col block which is the temporal neighboring block may be used as motion vector candidates. The aforementioned information about prediction may include a prediction motion vector index indicating the best motion vector selected from motion vector candidates included in the list. Here, the predictor 330 may select a prediction motion vector of the current block from the motion vector candidates included in the motion vector candidate list using the motion vector index. The predictor of the encoding device may obtain a motion vector difference (MVD) between the motion vector of the current block and a motion vector predictor, encode the MVD and output the encoded MVD in the form of a bitstream. That is, the MVD can be obtained by subtracting the motion vector predictor from the motion vector of the current block. Here, the predictor 330 may acquire a motion vector included in the information about prediction and derive the motion vector of the current block by adding the motion vector difference to the motion vector predictor. In addition, the predictor may obtain or derive a reference picture index indicating a reference picture from the aforementioned information about prediction.

The adder 340 can add a residual sample to a prediction sample to reconstruct a current block or a current picture. The adder 340 may reconstruct the current picture by adding the residual sample to the prediction sample in units of a block. When the skip mode is applied, a residual is not transmitted and thus the prediction sample may become a reconstructed sample. Although the adder 340 is described as a separate component, the adder 340 may be a part of the predictor 330. Meanwhile, the adder 340 may be referred to as a reconstructor or reconstructed block generator.

The filter 350 may apply deblocking filtering, sample adaptive offset and/or ALF to the reconstructed picture. Here, sample adaptive offset may be applied in units of a sample after deblocking filtering. The ALF may be applied after deblocking filtering and/or application of sample adaptive offset.

The memory 360 may store a reconstructed picture (decoded picture) or information necessary for decoding. Here, the reconstructed picture may be the reconstructed picture filtered by the filter 350. For example, the memory 360 may store pictures used for inter-prediction. Here, the pictures used for inter-prediction may be designated according to a reference picture set or a reference picture list. A reconstructed picture may be used as a reference picture for other pictures. The memory 360 may output reconstructed pictures in an output order.

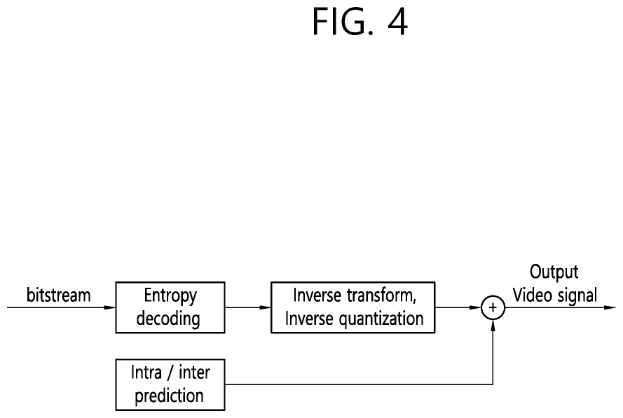

FIG. 4 illustrates an example of an image decoding method performed by a decoding device. Referring to FIG. 4, the image decoding method may include process of entropy decoding, inverse quantization, inverse transform and intra/inter prediction. For example, an inverse process of the encoding method may be performed in the decoding device. Particularly, through the entropy decoding for a bitstream, quantized transform coefficients may be obtained, and through the inverse quantization process for the quantized transform coefficients, a coefficient block of a current block, that is, transform coefficients may be obtained. Through the inverse transform for the transform coefficients, a residual block of the current block may be derived, and through summation between a prediction block of the current block derived through the intra/inter prediction and the residual block, a reconstructed block of the current block may be derived.

Meanwhile, in the case that the intra prediction is performed as described above, a correlation between samples may be used, and a difference between an original block and a prediction block, that is, a residual may be obtained. Since the transform and the quantization may be applied to the residual, through this, spatial redundancy may be removed. Particularly, the encoding method and the decoding method to which the intra prediction is used may be described below.

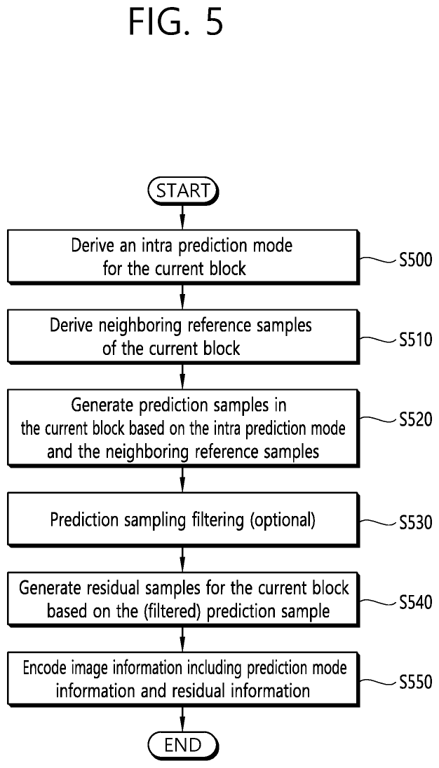

FIG. 5 illustrates an example of an image encoding method based on intra prediction. Referring to FIG. 5, the encoding device may derive an intra prediction mode for the current block (step, S500) and derive neighboring reference samples of the current block (step, S510). The encoding device may generate prediction samples in the current block based on the intra prediction mode and the neighboring reference samples (step, S520). In this case, the encoding device may perform a prediction sample filtering procedure (step, S530). The prediction sample filtering may be called a post filtering. By the prediction sample filtering procedure, a part or the whole of the prediction samples may be filtered. According to a situation, step S530 may be omitted.

The encoding device may generate residual samples for the current block based on the (filtered) prediction sample (step, S540). The encoding device may encode image information including prediction mode information representing the intra prediction mode and residual information for the residual samples (step, S550). The encoded image information may be output in a bitstream format. The output bitstream may be transferred to the decoding device through a storage medium or a network.

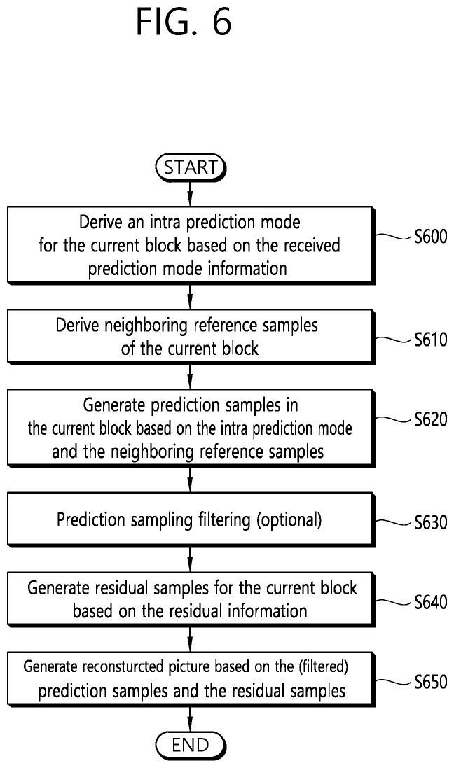

FIG. 6 illustrates an example of an image decoding method based on intra prediction. Referring to FIG. 6, the decoding device may perform an operation that corresponds to the operation performed in the encoding device. For example, the decoding device may derive an intra prediction mode for the current block based on the received prediction mode information (step, S600). The decoding device may derive neighboring reference samples of the current block (step, S610). The decoding device may generate prediction samples in the current block based on the intra prediction mode and the neighboring reference samples (step, S620). In this case, the decoding device may perform prediction sample filtering procedure (step, S630). By the prediction sample filtering procedure, a part or the whole of the prediction samples may be filtered. According to a situation, step S630 may be omitted.

The decoding device may generate residual samples for the current block based on the received residual information (step, S640). The decoding device may generate reconstructed samples for the current block based on the (filtered) prediction samples and the residual samples, and based on it, generate a reconstructed picture (step, S650).

Meanwhile, in the case that the intra prediction is applied to the current block, as described above, the encoding device/decoding device may derive an intra prediction mode for the current block and derive a prediction sample of the current block based on the intra prediction mode. That is, the encoding device/decoding device may apply directional mode or non-directional mode based on the neighboring reference sample of the current block and derive the prediction sample of the current block.

For reference, for example, the intra prediction mode may include two non-directional or non-angular intra prediction modes and 65 directional or angular intra prediction modes. The non-directional intra prediction modes may include #0 planar intra prediction mode and #1 DC intra prediction mode, and the directional intra prediction modes may include 65 intra prediction modes from #2 to #66. However, this is just an example, but the present disclosure may be applied to a case in which the number of intra prediction modes is different. Meanwhile, according to a situation, #67 intra prediction mode may be further used, and the #67 intra prediction mode may represent a linear model (LM) mode.

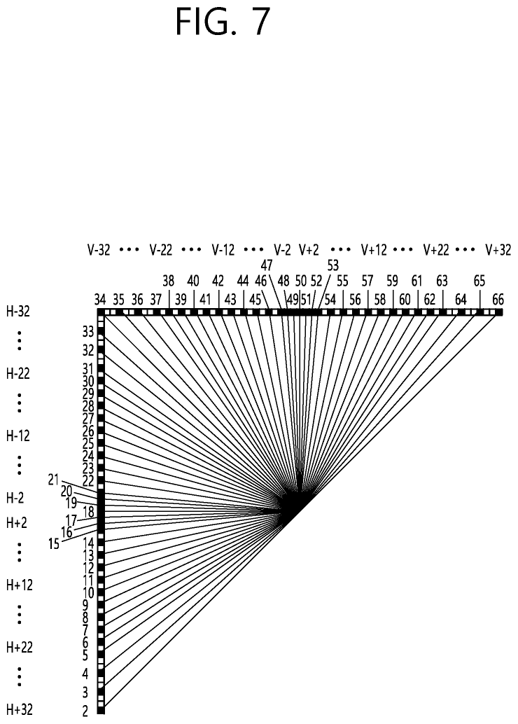

FIG. 7 illustrates intra-directional modes of 65 prediction directions.

Referring to FIG. 7, intra-prediction modes having horizontal directionality and intra-prediction modes having vertical directionality may be classified based on an intra-prediction mode #34 having an upper left diagonal prediction direction. H and V in FIG. 7 represent the horizontal directionality and the vertical directionality, respectively, and the numbers from −32 to 32 represent displacements of 1/32 unit on sample grid positions. The intra-prediction modes #2 to #33 have the horizontal directionality and the intra-prediction modes #34 to #66 have the vertical directionality.

#18 intra prediction mode and #50 intra prediction mode may represent a horizontal intra prediction mode and a vertical intra prediction mode, respectively. #2 intra prediction mode may be called a lower left directional diagonal intra prediction mode, #34 intra prediction mode may be called an upper left directional diagonal intra prediction mode, and #66 intra prediction mode may be called an upper right directional diagonal intra prediction mode.

Meanwhile, the prediction mode information may include flag information (e.g., prev_intra_luma_pred_flag) that represents whether the most probable mode (MPM) is applied to the current block or the remaining mode is applied to the current block. In addition, in the case that the MPM is applied to the current block, the prediction mode information may further include index information (e.g., mpm_idx) indicating one of the intra prediction mode candidates (e.g., MPM candidates). Meanwhile, the intra prediction mode candidates for the current block may be constructed by the MPM candidate list or the MPM list. That is, the MPM candidate list or the MPM list for the current block may be constructed, and the MPM candidate list or the MPM list may include the intra prediction mode candidates.

In addition, in the case that the MPM is not applied to the current block, the prediction mode information may further include remaining intra prediction mode information (e.g., rem_inra_luma_pred_mode) indicating one of the remaining intra prediction modes except the intra prediction mode candidates. The remaining intra prediction mode information may also be referred to as MPM remainder information.

The decoding device may determine an intra prediction mode of the current block based on the prediction mode information. The prediction mode information may be encoded/decoded through a coding method described below. For example, the prediction mode information may be encoded/decoded through entropy coding (e.g., CABAC, CAVLC) based on truncated binary code or truncated rice binary code.

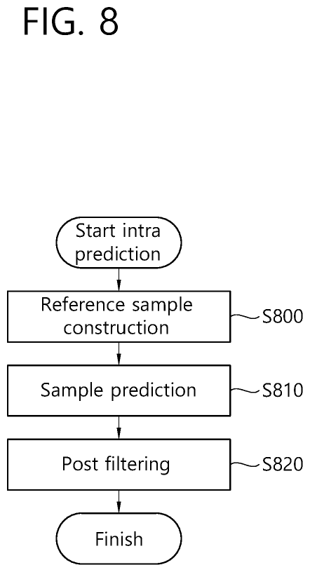

FIG. 8 illustrates an example of performing an intra prediction. Referring to FIG. 8, a general intra prediction may be performed by three steps. For example, in the case that the intra prediction is applied to a current block, the encoding device/decoding device may construct a reference sample (step, S800), derive a prediction sample for the current block based on the reference sample (step, S810) and perform a post filtering for the prediction sample (step, S820). The prediction unit of the encoding device/decoding device may obtain advantages of the intra prediction mode and known neighboring reference samples for generating unknown samples of the current block.

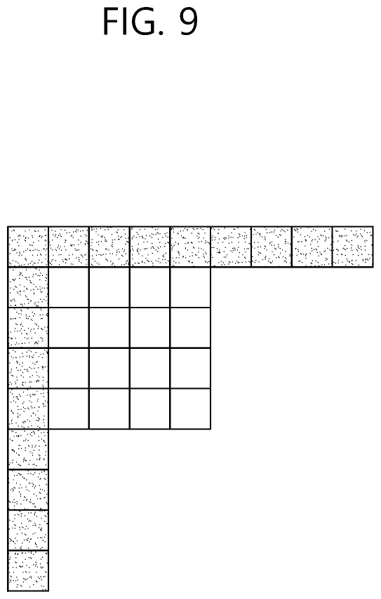

FIG. 9 illustrates the neighboring samples used for an intra prediction of the current block. Referring to FIG. 9, in the case that a size of the current block is W×H, the neighboring samples of the current block may include 2W upper neighboring samples, 2H left neighboring samples and upper left corner neighboring samples. For example, in the case that a size of the current block is W×H and x component of top left sample position of the current block is 0 and y component is 0, the left neighboring samples may be p[−1][0] to p[−1][2H−1], the upper left corner neighboring samples may be p[−1][−1] and the upper neighboring samples may be p[0][−1] to p[2W−1][−1]. A prediction sample of a target sample may be derived based on the neighboring sample located in a prediction direction of the intra prediction mode of the current block in accordance with the target sample of the current block. Meanwhile, a plurality of lines of neighboring samples may be used for an intra prediction of the current block.

Meanwhile, the encoding device may determine an optimal intra prediction mode for the current block by jointly optimizing a bit rate and a distortion. Later, the encoding device may code the prediction mode information for the optimal intra prediction mode in a bitstream. The decoding device may derive the optimal intra prediction mode by parsing the prediction mode information and perform an intra prediction of the current block based on the intra prediction mode. However, the increased number of intra prediction modes requires an efficient intra prediction mode coding for minimizing signaling overhead.

Accordingly, the present disclosure proposes embodiments for reducing signaling overhead in transmitting information for intra prediction.

Meanwhile, operators in the embodiments described below may be defined as the Table below.

TABLE 1

| | |
|---|---|
| Floor(x) | the largest integer less than or equal to x. |
| Log2(u) | the base-2 logarithm of u. |
| Ceil(x) | the smallest integer greater than or equal to x. |
| x >> y | Arithmetic right shift of a two's complement integer |

representation of x by y binary digits. This function is
defined only for non-negative integer values of y. Bits
shifted into the MSBs as a result of the right shift have a
value equal to the MSB of x prior to the shift operation.

| | |
|---|---|
| x << y | Arithmetic left shift of a two's complement integer |

representation of x by y binary digits. This function is
defined only for non-negative integer values of y. Bits shifted
into the LSBs as a result of the left shift have a value equal to 0.

| | |
|---|---|
| > | Greater than. |
| >= | Greater than or equal to. |
| < | Less than. |
| <= | Less than or equal to. |
| == | Equal to. |
| != | Not equal to. |

Referring to Table 1, Floor(x) may represent a maximum integer value of x or smaller, Log 2(u) may represents a log value having 2 of u as a base and Ceil(x) may represent a minimum integer value of x or greater. For example, the case of Floor(5.93) may indicate 5, since a maximum integer value of 5.93 or smaller is 5.

In addition, referring to Table 1, x>>y may represent an operator that right-shifts x by y times and x<<y may represent an operator that left-shifts x by y times.

Generally, a current block and a neighboring block to be coded may have similar image property, and accordingly, since the current block and the neighboring block have high probability of having the same or similar intra prediction mode, to deriving the intra prediction mode applied to the current block, MPM list of the current block may be determined based on the intra prediction mode of the neighboring block. That is, for example, the MPM list may include the intra prediction mode of the neighboring block as an MPM candidate.

The neighboring block of the current block used for constructing the MPM list of the current block may be represented as below.

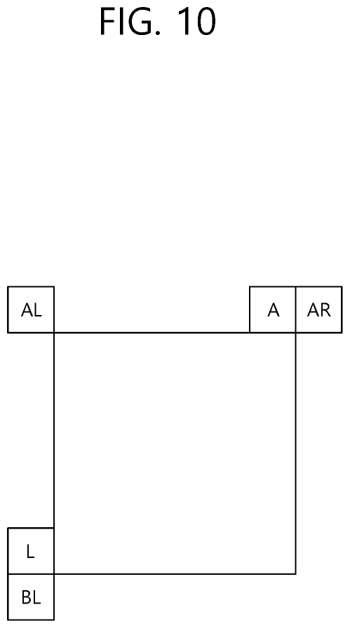

FIG. 10 illustrates neighboring blocks of the current block. Referring to FIG. 10, the neighboring blocks of the current block may include a left neighboring block, an upper neighboring block, a lower left neighboring block, an upper right neighboring block and/or an upper left neighboring block. Here, in the case that a size of the current block is W×H and x component of top left sample position of the current block is 0 and y component is 0, the left neighboring block may be a block including a sample of (−1, H−1) coordinate, the upper neighboring block may be a block including a sample of (W−1, −1) coordinate, the upper right neighboring block may be a block including a sample of (W, −1) coordinate, the lower left neighboring block may be a block including a sample of (−1, H) coordinate and the upper left neighboring block may be a block including a sample of (−1, −1) coordinate.

The decoding device may construct the MPM list of the current block and derive the MPM candidate indicated by an MPM index among the MPM candidates of the MPM list as the intra prediction mode of the current block. The MPM index may be signaled in the case that one of the MPM candidates is the optimal intra prediction mode for the current block, and accordingly, overhead may be minimized. The index indicating the MPM candidates may be coded with truncated unary code. That is, the MPM index may be binarized by using the truncated unary code. The value of the MPM index binarized by using the truncated unary code may be represented as the Table below.

TABLE 2

| | | |
|---|---|---|
| 0 | → | 0 |
| 1 | → | 1 0 |
| 2 | → | 1 0 |
| 3 | → | 1 1 0 |
| 4 | → | 1 1 1 0 |
| 5 | → | 1 1 1 1 1 |
| | | \| \| \| \| \| |

| | |
|---|---|
| Bin: | 0 1 2 3 4 |

Referring to Table 2, the MPM index may be derived as binary values of 1 to 5 bins depending on the represented value. Since the bin of binary value is small as the value of the MPM index is small which is binarized through the truncated unary code, an order of the MPM candidates may be important to reduce an amount of bit. In addition, the truncated unary code may also be referred to as Truncated Rice code.

For example, the Most Probable Mode (MPM) list of the current block may include 6 MPM candidates, and the MPM candidates may be constructed in an order of an intra prediction mode of a left neighboring block, an intra prediction mode of an upper neighboring block, a planar intra prediction mode, a DC intra prediction mode, an intra prediction mode of a lower left neighboring block, an intra prediction mode of an upper right neighboring block and an intra prediction mode of an upper left neighboring block. Meanwhile, in the case that an optimal intra prediction mode for the current block is not included in the MPM list, an MPM flag may be signaled to indicate an exception. That is, the MPM flag may indicate whether an intra prediction mode applied to the current block is included in the MPM candidates or included in the remaining intra prediction modes which are not included in the MPM candidates. Particularly, in the case that the value of MPM flag is 1, the MPM flag may indicate that an intra prediction mode of the current block is included in the MPM candidates (MPM list), and in the case that the value of MPM flag is 0, the MPM flag may indicate that an intra prediction mode of the current block is not included in the MPM candidates (MPM list) but included in the remaining intra prediction modes.

Meanwhile, the optimal intra prediction mode for the current block, that is, an index representing an intra prediction mode applied to the current block may be coded by using a variable length coding or a fixed length coding. In addition, the number of MPM candidates included in the MPM list may be determined based on the number of intra prediction modes. For example, as the number of intra prediction modes increase, the number of MPM candidates may increase or may not. For example, the MPM list may include 3 MPM candidates, 5 MPM candidates or 6 MPM candidates.

Meanwhile, as described above, an index representing an intra prediction mode applied to the current block may be coded by using a variable length coding or a fixed length coding. Here, in the case that the index is coded by the variable length coding, as the probability that an intra prediction mode of higher order (i.e., an intra prediction mode corresponding to the case that the index value is small) is selected is higher, an amount of bit of the prediction mode information representing an intra prediction mode of an image, and accordingly, a coding efficiency may be improved in comparison with the case that the fixed length coding is used.

As the variable length coding, the truncated binary coding may be used.

For example, in the case that total u symbols are coded by the truncated binary coding, the first l symbols may be coded by using k bits, and u−1 symbols, that is, the symbols excluding l symbols from the total u symbols may be coded by using k+1 bit. Here, the first l symbols may represent l symbols of high order. Meanwhile, the symbols may be values in which information may be represented.

Here, the k may be derived as represented in the following Equation.

k=floor(Log 2(u)) [Equation 1]

In addition, the l may be derived as represented in the following Equation.

l=2^{k+1}−u [Equation 2]

For example, k and l according to the symbol number in which the truncated binary coding may be used may be derived as represented in the following Table.

TABLE 3

| | k bit to code symbols | |
|---|---|---|
| Total number of symbols u | first l symbols | First l symbols |
| 29 | 4 | 3 |
| 61 | 5 | 3 |
| 62 | 5 | 2 |

In addition, for example, in the case that the number of total symbols is 61 (u=61), a binary value for each symbol according to the truncated binary coding may be derived as represented in the following Table.

TABLE 4

| Input symbols | Mapped value | binary | Number of bits use to code |
|---|---|---|---|
| 0 | 0 | 00000 | 5 |
| 1 | 1 | 00001 | 5 |
| 2 | 2 | 00010 | 5 |
| 3 | 6 | 000110 | 6 |
| 4 | 7 | 000111 | 6 |
| 5 | 8 | 001000 | 6 |
| . . . | . . . | | . . . |
| 60 | 63 | 111111 | 6 |

Referring to Table 4, in the case that the number of total symbols is 61 (i.e., cMax+1), the k may be derived to 5, and the l may be derived to 3. Accordingly, symbols 0 to 2 may be coded with a binary value having 5-bit number, and the remaining symbols may be coded with a binary value having 6 (i.e., k+1)-bit number.

Meanwhile, the symbols may represent indexes of the intra prediction mode list. That is, indexes of the intra prediction modes of a specific order. For example, the intra prediction mode list may be a list constructed in an ascending order of mode numbers as below.

{0, 1, 2, . . . , 64, 65, 66}

Alternatively, for example, the intra prediction mode list may be a list constructed in a pre-defined order as below.

{66, 50, 34, . . . , 2, 18}

The present disclosure proposes a method for coding information for representing an intra prediction mode by using the truncated binary coding described above.

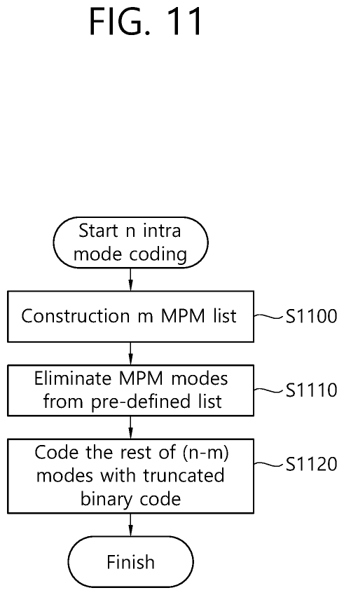

FIG. 11 exemplarily illustrates a method for coding information for representing n intra prediction modes including MPM candidates and remaining intra prediction modes.

Referring to FIG. 11, the encoding apparatus constructs an MPM list including m MPM candidates (S1100). Thereafter, the encoding apparatus may remove the MPM candidates from a predefined intra prediction mode list (S1110). Thereafter, an index indicating the (n−m) remaining intra prediction modes may be coded by using the truncated binary code (S1120). That is, an index indicating one of the (n−m) remaining intra prediction modes may be coded by using the truncated binary code. For example, when the value of the index is N, the remaining intra prediction mode information may indicate an N+1-th intra prediction mode among the (n−m) remaining intra prediction modes. As described above, the index indicating the (n−m) remaining intra prediction modes may be coded by using the truncated binary code. That is, for example, when the value of the index is N, the index may be binarized to a binary value corresponding to the N in the truncated binary code.

Meanwhile, the intra prediction mode list may also be referred to as an intra mode map. The intra mode map may indicate a pre-defined order of all u intra prediction modes. That is, the intra mode map may indicate intra prediction modes except for the MPM candidates from the intra prediction modes in a preset order. The remaining intra prediction modes except for the m MPM candidates from all intra prediction modes may be mapped to the symbol of the index in an order (i.e., the preset order) according to the intra mode map. For example, among the intra prediction modes except for the m MPM candidates, the index of the intra prediction mode in a first order in the intra mode map may be 0 and the index of the intra prediction mode in an n-th order may be n−1.

Further, first l symbols of the truncated binary code use a smaller number of bits than the remaining symbols, so that as an example, an intra mode map may be proposed, in which intra prediction modes which are highly selectable as an optimal intra prediction mode in a rate-distortion optimization (RDO) process are included in a preceding order. For example, the intra mode map may be as follows. That is, the intra prediction modes in the preset order may be as follows.

{0, 1, 50, 18, 49, 10, 12, 19, 11, 34, 2, 17, 54, 33, 46, 51, 35, 15, 13, 45, 22, 14, 66, 21, 47, 48, 23, 53, 58, 16, 42, 20, 24, 44, 26, 43, 55, 52, 37, 29, 39, 41, 25, 9, 38, 56, 30, 36, 32, 28, 62, 27, 40, 8, 3, 7, 57, 6, 31, 4, 65, 64, 5, 59, 60, 61, 63}

For example, when the number of intra prediction modes is 67 and the number of MPM candidates is 6, 61 remaining intra prediction modes may be coded by using the truncated binary code. That is, the indexes for the remaining intra prediction modes may be coded based on the truncated binary code. When the 6 MPM candidates are derived, the 6 MPM candidates may be removed from the intra mode map. Then, in order to reduce the amount of bits, three (1 for u being 61 is 3) intra prediction modes in the preceding order, i.e., three intra predictions in the preceding order in the intra mode map among the remaining intra prediction modes are may be coded with 00000, 00001, and 00010 of 5 (k for u being 61 is 5) bits. That is, among the 61 remaining intra prediction modes, the index of a first intra prediction mode according to the intra mode map may be coded with a binary value of 00000, the index of a second intra prediction mode may be coded with a binary value of 00001, and the index of a third intra prediction mode may be coded with a binary value of 00010. 58 intra prediction modes other than the 3 intra prediction modes may be coded by a truncated binary code of 6 bits, such as 000100 or 000101. That is, the indexes of 58 intra prediction modes other than the 3 intra prediction modes may be coded with a binary value of 6 bits, such as 000100 or 000101.

The present disclosure also proposes another embodiment of coding the information for indicating the intra prediction mode by using the truncated binary code.

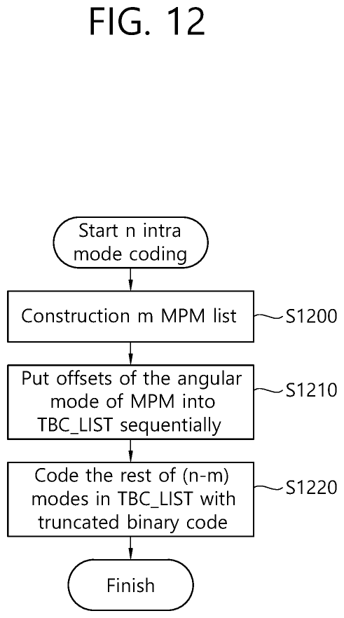

FIG. 12 exemplarily illustrates a method for coding information for representing n intra prediction modes including MPM candidates and remaining intra prediction modes.

Referring to FIG. 12, the encoding apparatus constructs an MPM list including m MPM candidates (S1200). Thereafter, the encoding apparatus may encapsulate an offset of a directional intra prediction mode among the MPM candidates in the TBC list (S1210). For example, when the directional intra prediction mode, which is the MPM candidates, is intra prediction mode # n, intra prediction mode # n+offset obtained by adding the offset to n may be derived and the TBC list including the intra prediction mode # n+offset may be constructed. Here, the offset may start at −1, +1, −2, +2, . . . , −4, +4. Thereafter, indexes indicating the (n−m) remaining intra prediction modes may be coded by using the truncated binary code (S1220). As described above, the index indicating the (n−m) remaining intra prediction modes may be coded by using the truncated binary code.

For example, when the number of intra prediction modes is 67 and the number of MPM candidates is 6, 61 remaining intra prediction modes may be coded by using the truncated binary code. That is, the indexes for the remaining intra prediction modes may be coded based on the truncated binary code. For example, when six MPM candidates included in the MPM list are {50, 8, 0, 1, 66, 54}, the TBC list may be constituted by {49, 51, 7, 9, 65, 53, 55, . . . ,}. Specifically, the directional intra prediction mode among the MPM candidates is intra prediction mode #50, intra prediction mode #8, intra prediction mode #66, and intra prediction mode #54 and the intra prediction mode derived based on intra prediction mode #50, and intra prediction mode #8, intra prediction mode #66, and intra prediction mode #54 and the offset may be added to the TBC list.

Then, in order to reduce the amount of bits, three (l for u being 61 is 3) intra prediction modes in the preceding order, i.e., three intra predictions in the preceding order in the TBC list among the remaining intra prediction modes are may be coded with 00000, 00001, and 00010 of 5 (k for u being 61 is 5) bits. That is, among the 61 remaining intra prediction modes, the index of intra prediction mode #49 which is the first intra prediction mode in the TBC list may be coded with a binary value of 00000, the index of intra prediction mode #51 which is the second intra prediction mode may be coded with a binary value of 00001, and the index of intra prediction mode #7 which is the third intra prediction mode may be coded with a binary value of 00010. Further, 58 intra prediction modes other than the 3 intra prediction modes may be coded by a truncated binary code of 6 bits, such as 000100 or 000101. That is, the indexes of 58 intra prediction modes other than the 3 intra prediction modes may be coded with a binary value of 6 bits, such as 000100 or 000101.

Meanwhile, the MPM index may be signaled in the form of the mpm_idx[x0+i][y0+j] (or mpm_idx) syntax element and the remaining intra prediction mode information may be signaled in the form of the rem_intra_luma_pred_mode[x0+i] [y0+j] (or rem_intra_lum_apred_mode) syntax element. Alternatively, the MPM index may be signaled in the form of the intra_luma_mpm_idx[xCb][yCb] syntax element and the remaining intra prediction mode information may be signaled in the form of the intra_luma_mpm_remainder[xCb][yCb] syntax element. Here, the MPM index may indicate one of the MPM candidates and the remaining intra prediction mode information may indicate one of the remaining intra prediction modes other than the MPM candidates. Further, array indices (x0+i, y0+i) may indicate a location (x0+i, y0+i) of a top-left luma sample of the prediction block based on the top-left luma sample of the picture. In addition, array indices (xCb, yCb) may indicate a location (xCb, yCb) of the top-left luma sample of the prediction block based on the top-left luma sample of the picture.

In addition, binarization for remaining mode coding may be derived by invoking a truncated binary (TB) binarization process with a cMax value equal to (num_intra_mode−mpm_idx). That is, the binarization for the remaining mode coding may be performed by the truncated binary binarization process in which a cMax value is a value obtained by subtracting the number of MPM candidates from the total number of intra prediction modes. Here, the num_intra_mode may represent the total number of intra prediction modes and the mpm_idx may represent the number of MPM candidates.

Specifically, the truncated binary binarization process may be performed as follows.

The input of the process may be a request for TB binarization for syntax elements having the synVal value and the cMax value. Here, the synVal may represent the value of the syntax element and the cMax may represent the maximum value which may be indicated by the syntax element. Further, the output of the process may be the TB binarization of the syntax element. The bin string of the TB binarization process of the syntax element synVal may be specified as described below.

n=c Max+1

k=Floor(Log 2(n)) so that 2^{k}<=n<2k+1

u=2k⁺¹n [Equation 3]

Here, when the cMax is 0, the TB binarization of the syntax element may be a null bin string.

Further, when the cMax is not 0 and the synVal is smaller than u, the TB bin string may be derived by invoking a fixed length (FL) binarization process for an input symbolVal set to k and synVal having cMax. That is, when the cMax is not 0 and the synVal is smaller than u, the TB bin string may be derived based on the FL binarization process for the input symbolVal set to k and synVal having cMax set to k. According to Equation 4 to derive the length of the binary value in the fixed length process to be described below, i.e., the number of bits, the number of bits may be derived as k with respect to cMax set to the k. Accordingly, when the synVal is smaller than u, a binary value of k bits for the synVal may be derived.

Further, the cMax is not 0 and the synVal is larger than or equal to u, the TB bin string may be derived by invoking the fixed length (FL) binarization process for an input symbolVal set to (k+1) and synVal+u having cMax. That is, when the cMax is not 0 and the synVal is larger than or equal to u, the TB bin string may be derived based on the FL binarization process for the input symbolVal set to (k+1) and synVal+u having cMax set to (k+1). According to Equation 4 to derive the length of the binary value in the fixed length process to be described below, i.e., the number of bits, the number of bits may be derived as (k+1) with respect to cMax set to the (k+1). Accordingly, when the synVal is larger than or equal to u, a binary value of (k+1) bits for the synVal may be derived.

In addition, as another example, binarization for remaining mode coding may be derived by invoking a fixed length (FL) binarization process with a cMax value equal to (num_intra_mode−mpm_idx). That is, the binarization for the remaining mode coding may be performed by the FL binarization process in which the cMax value is a value obtained by subtracting the number of MPM candidates from the total number of intra prediction modes. Here, the num_intra_mode may represent the total number of intra prediction modes and the mpm_idx may represent the number of MPM candidates.

Specifically, the FL binarization process may be performed as follows.

The input of the process may be a request for cMax and FL binarization. Further, the output of the process may be FL binarization that associates each symbolVal value with a corresponding bin string.

The FL binarization may be configured by using an unsigned integer bin string which is a fixed length bit of the symbol value symbolVal.

Here, the fixed length may be derived as shown in an equation below.

fixedLength=Ceil(Log 2(c Max+1)) [Equation 4]

Here, the fixedLength may represent the fixed length.

Indexing bins for the FL binarization, binIdx=0 may be associated with a most important bit and as a binIdx value increases, the indexing may be associated with bits which are not important and a case where the binIdx value is the largest may be associated with bits which are not most important.

The remaining intra prediction mode information may be binarized and coded by the TR binarization process or FL binarization process with respect to the aforementioned contents.

For example, the MPM index and the remaining intra prediction mode information may be binarized as shown in a table below.

TABLE 5

| | | Binarization | |
|---|---|---|---|
| Syntax structure | Syntax element | Process | Input parameters |
| . . . | . . . | . . . | . . . |
| coding unit( ) | rem_intra_luma_pred_model[ ][ ] | FL | cMax = number of total intramode − mpm_idx |
| | mpm_idx[ ][ ] | TR | cMax = mpm_idx−1, cRiceParam = 0 |
| | . . . | . . . | . . . |

Here, rem_intra_luma_pred_mode[ ][ ] may be the syntax element indicating the remaining intra prediction mode information and mpm_idx[ ][ ] may be the syntax element indicating the MPM index. Referring to Table 5 described above, the remaining intra prediction mode information may be binarized by the FL binarization process and cMax, an input parameter of the FL binarization process, may be a value obtained by subtracting the number of MPM candidates from the total number of intra prediction modes. For example, when the total number of intra prediction modes is 67 and the number of MPM candidates is 6, considering 61 remaining intra prediction modes from 0 to 60 (that is, when index values indicating the remaining intra prediction modes are 0 to 60), the cMax may be 60. As another example, by considering that the 61 remaining intra prediction modes 1 to 61 (that is, when the index values indicating the remaining intra prediction modes are 1 to 61), the cMax may be 61. That is, the cMax may be the maximum value which may be indicated by the remaining intra prediction mode information. Further, referring to Table 5 described above, the MPM index may be binarized by a truncated rice (TR) binarization process, and cMax which is the input parameter of the TR binarization process may be a value obtained by subtracting 1 from the number of MPM candidates and cRiceParam may be 0. For example, when the number of MPM candidates is 6, the cMax may be 5.

Alternatively, for example, the MPM index and the remaining intra prediction mode information may be binarized as shown in a table below.

TABLE 6

| | | Binarization | |
|---|---|---|---|
| Syntax structure | Syntax element | Process | Input parameters |
| . . . | . . . | . . . | . . . |
| coding unit( ) | rem_intra_luma_pred_mode[ ][ ] | TB | cMax = number of total intramode − mpm_idx |
| | mpm_idx[ ][ ] | TR | cMax = mpm_idx−1, cRiceParam = 0 |
| | . . . | . . . | . . . |

Here, rem_intra_luma_pred_mode[ ][ ] may be the syntax element indicating the remaining intra prediction mode information and mpm_idx[ ][ ] may be the syntax element indicating the MPM index. Referring to Table 5 described above, the remaining intra prediction mode information may be binarized by the TB binarization process and cMax, which is the input parameter of the FL binarization process, may be a value obtained by subtracting the number of MPM candidates from the total number of intra prediction modes. For example, when the total number of intra prediction modes is 67 and the number of MPM candidates is 6, considering 61 remaining intra prediction modes from 0 to 60 (that is, when index values indicating the remaining intra prediction modes are 0 to 60), the cMax may be 60. As another example, by considering that the 61 remaining intra prediction modes 1 to 61 (that is, when the index values indicating the remaining intra prediction modes are 1 to 61), the cMax may be 61. That is, the cMax may be the maximum value which may be indicated by the remaining intra prediction mode information. Further, referring to Table 6 described above, the MPM index may be binarized by a truncated rice (TR) binarization process, and cMax which is the input parameter of the TR binarization process may be a value obtained by subtracting 1 from the number of MPM candidates and cRiceParam may be 0. For example, when the number of MPM candidates is 6, the cMax may be 5.

Meanwhile, as an example, the MPM index may be encoded/decoded based on a context model. The present disclosure proposes a method for deriving the context model based on an intra prediction mode in relation to a method for encoding/decoding the MPM index based on the context model.

For example, assignment of the context model for the MPM index may be shown in an equation below.

```
TABLE 7
If(NUM_INTRA_MODE == INTRA_DC ∥ NUM_INTRA_MODE ==
INTRA_PLANAR)
  mpmCtx =1
else if (NUM_INTRA_MODE <= INTRA_ANGULAR34 )
  mpmCtx =2
else
  mpmCtx =2
```

Here, for example, may represent a number of the intra prediction mode represented by an M-th MPM candidate included in the MPM list. That is, when the M-th MPM candidate is in intra prediction mode # N, the NUM_INTRA_MODE may show N. Further, mpmCtx may represent the context model for the MPM index. In this case, the context model for an M-th bin of the MPM index may be derived based on the M-th candidate included in the MPM list. Here, the M may be 3 or less.

For example, the context model for a first bin in the intra prediction mode information for the current block may be derived based on a first candidate included in the MPM list. In addition, the context model for a second bin may be derived based on the second candidate included in the MPM list, and the context model for a third bin may be derived based on the third candidate included in the MPM list.

Meanwhile, the number of the intra prediction mode may be shown in a table below.

TABLE 8

| Intra prediction mode | Associated name |
|---|---|
| 0 | INTRA_PLANAR |
| 1 | INTRA_DC |
| 2 . . . 66 | INTRA_ANGULAR2..INTRA_ANGULAR66 |

Referring to Table 7 described above, when the number of the intra prediction mode indicated by the M-th MPM candidate is the number (i.e., 1) of the DC intra prediction mode or when the number of the intra prediction mode is a planar intra prediction mode (i.e., 0), the context model for the M-th bin of the MPM index may be derived as context model 1. In other words, when the M-th MPM candidate is in the DC intra prediction mode or when the M-th MPM candidate is in the planner intra prediction mode, the context model for the M-th bin of the MPM index may be derived as context model 1.

Further, when the aforementioned condition is not satisfied and the number of the intra prediction mode indicated by the M-th MPM candidate is equal to or smaller than 34, the context model for the M-th bin of the MPM index may be derived as context model 2. In other words, when the M-th MPM candidate is in the DC intra prediction mode and the intra prediction mode is not the planar intra prediction mode and when the M-th MPM candidate is in intra prediction modes #2 to #34, the context model for the M-th bin of the MPM index may be derived as context model 2.

Further, when all of the aforementioned conditions are not satisfied, the context model for the M-th bin of the MPM index may be derived as context model 2 or context model 3. In other words, when the M-th MPM candidate is in intra prediction modes #35 to #66, the context model for the M-th bin of the MPM index may be derived as context model 2 or context model 3.

Alternatively, as another example, the assignment of the context model for the MPM index may be shown in a table below.

```
TABLE 9
If(NUM_INTRA_MODE == INTRA_PLANAR )
  mpmCtx =1
else if (NUM_INTRA_MODE == INTRA_DC )
  mpmCtx =2
else if (NUM_INTRA_MODE <= INTRA_ANGULAR34 )
  mpmCtx =3
else
  mpmCtx =4
```

For example, referring to Table 9 described above, when the number of the intra prediction mode indicated by the M-th MPM candidate is the planar intra prediction mode (i.e., 0), the context model for the M-th bin of the MPM index may be derived as context model 1. In other words, when the M-th MPM candidate is in the planner intra prediction mode, the context model for the M-th bin of the MPM index may be derived as context model 1.

Further, when the aforementioned condition is not satisfied and the number of the intra prediction mode indicated by the M-th MPM candidate is the number (i.e., 1) of the DC intra prediction mode, the context model for the M-th bin of the MPM index may be derived as context model 2. In other words, when the M-th MPM candidate is not in the planar intra prediction mode or when the M-th MPM candidate is in the DC intra prediction mode, the context model for the M-th bin of the MPM index may be derived as context model 2.

Further, when the aforementioned conditions are not satisfied and the number of the intra prediction mode indicated by the M-th MPM candidate is equal to or smaller than 34, the context model for the M-th bin of the MPM index may be derived as context model 3. In other words, when the M-th MPM candidate is not in the DC intra prediction mode and the planar intra prediction mode and the M-th MPM candidate is in intra prediction modes #2 to #34, the context model for the M-th bin of the MPM index may be derived as context model 3.

Further, when all of the aforementioned conditions are not satisfied, the context model for the M-th bin of the MPM index may be derived as context model 4. In other words, when the M-th MPM candidate is not in the DC intra prediction mode, the planar intra prediction mode, and intra prediction modes #2 to #34, but in intra prediction modes #35 to #66, the context model for the M-th bin of the MPM index may be derived as context model 4.

Further, for example, ctxInc for the syntax element having context based coded bins of the MPM index may be assigned as shown in a table below.

TABLE 10

| | binIdx | | | | | |
|---|---|---|---|---|---|---|
| Syntax element | 0 | 1 | 2 | 3 | 4 | >=5 |
| rem_intra_luma_pred_mode[ ][ ] | bypass | bypass | bypass | bypass | bypass | bypass |
| mpm_idx[ ][ ] | 0 | 1 | 2 | bypass | bypass | na |

Here, rem_intra_luma_pred_mode[ ][ ] may be a syntax element indicating remaining intra prediction mode information and mpm_idx[ ][ ] may be a syntax element indicating the MPM index. Further, the binIdx may represent the index of the syntax element.

Referring to Table 10, bins 0, 1, and 2 of the MPM index may be coded based on the context model, ctxInc for the bin 0 may be derived as 0, ctxInc for the bin 1 may be derived as 1, and ctxInc for the bin 2 may be derived as 2. Meanwhile, the bypass coding may be applied to the bins 3 and 4 of the MPM index. The bypass coding may represent a method for the coding method through application of the uniform probability distribution (e.g., 50:50) instead of applying the context model having the specific probability distribution.

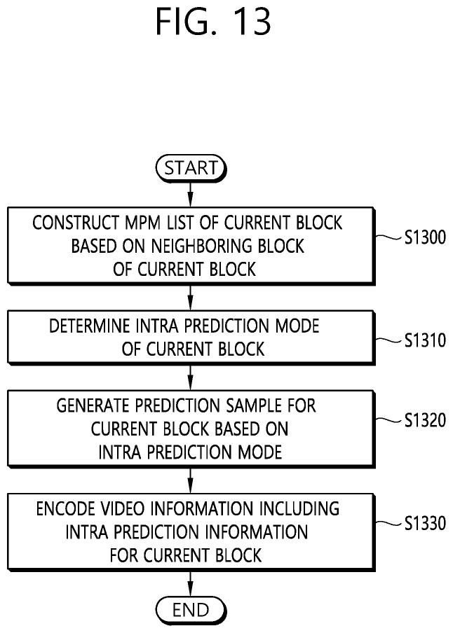

FIG. 13 schematically illustrates a video encoding method by an encoding apparatus according to the present disclosure. The method disclosed in FIG. 13 may be performed by the encoding apparatus disclosed in FIG. 1. Specifically, for example, S1300 to S1320 of FIG. 13 may be performed by the prediction unit of the encoding apparatus and S1330 may be performed by the entropy encoder of the encoding apparatus. In addition, although not illustrated, a process of deriving a residual sample for the current block based on an original sample and a prediction sample for the current block may be performed by a subtraction unit of the encoding apparatus and a process of generating information on the residual for the current block may be performed by a converter of the encoding apparatus and a process of encoding the information on the residual may be performed by an entropy encoder of the encoding apparatus.

The encoding apparatus may construct the Most Probable Mode (MPM) list of the current block based on the neighboring block of the current block (S1300). Here, as an example, the MPM list may include three MPM candidates, five MPM candidates, or six MPM candidates.

For example, the encoding apparatus may construct the MPM list of the current block based on the neighboring block of the current block and the MPM list may include six MPM candidates. The neighboring block may include the left neighboring block, the upper neighboring block, the lower left neighboring block, the up-right neighboring block, and/or the up-left neighboring block of the current block. The encoding apparatus may search the neighboring blocks of the current block in a specific order and derive the intra prediction mode of the neighboring block as the MPM candidate in the derived order. For example, the encoding apparatus may derive the MPM candidate and the construct the MPM list of the current block by performing the search in the order of the intra prediction mode of the left neighboring block, the intra prediction mode of the upper neighboring block, the planner intra prediction mode, the DC intra prediction mode, the intra prediction mode of the lower left neighboring block, the intra prediction mode of the right upper neighboring block, and the intra prediction mode of the up-left neighboring block. Meanwhile, when six MPM candidates are not derived after the search, the MPM candidate may be derived based on the intra prediction mode derived as the MPM candidate. For example, when the intra prediction mode derived as the MPM candidate is intra prediction mode # N, the encoding apparatus may derive the intra prediction mode # N+1 and/or intra prediction mode # N−1 as the MPM candidate of the current block.

The encoding apparatus determines the intra prediction mode of the current block (S1310). The encoding apparatus performs various intra prediction modes to derive an intra prediction mode having optimal rate-distortion (RD) cost as the intra prediction mode for the current block. The intra prediction mode may be one of two non-directional intra prediction modes and 65 intra directional prediction modes. The two non-directional intra prediction modes may include an intra DC mode and an intra planar mode as described above.

For example, the intra prediction mode of the current block may be one of the remaining intra prediction modes. Here, the remaining intra prediction modes may be intra prediction modes except for the MPM candidates included in the MPM list in all intra prediction modes. Further, in this case, the encoding apparatus may encode the remaining intra prediction mode information indicating the intra prediction mode of the current block among the remaining intra prediction modes.

Further, for example, the encoding apparatus may select an MPM candidate having optimal RD cost among the MPM candidates of the MPM list and determine the selected MPM candidate as the intra prediction mode for the current block. In this case, the encoding apparatus may encode an MPM index indicating the selected MPM candidate among the MPM candidates.

The encoding apparatus generates the prediction sample of the current block based on the intra prediction mode (S1320). The encoding apparatus may derive at least one neighboring sample among the neighboring samples of the current block based on the intra prediction mode and generate the prediction sample based on the neighboring sample. The neighboring samples may include upper left corner neighboring samples, an upper left neighboring sample, upper neighboring samples, and left neighboring samples of the current block. For example, when the size of the current block is W×H and an x component of a top-left sample position of the current block is 0 and a y component is 0, the left neighboring samples may be p[−1][0] to p[−1][2H−1], the upper left corner neighboring sample may be p[−1][−1], and the upper neighboring samples may be p[0][−1] to p[2W−1][4].

The encoding apparatus encodes video information including intra prediction information of the current block (S1330). The encoding apparatus may output the video information including the intra prediction information for the current block in the form of a bitstream.

The intra prediction information may include a Most Probable Mode (MPM) flag for the current block. The MPM flag may indicate whether the intra prediction mode of the current block is included in the MPM candidates or included in the remaining intra prediction modes which are not included in the MPM candidates. Specifically, when the value of the MPM flag is 1, the MPM flag may indicate that the intra prediction mode of the current block is included in the MPM candidates and when the value of the MPM flag is 0, the MPM flag may indicate that the intra prediction mode of the current block is not included in the MPM candidates, i.e., the intra prediction mode of the current block is included in the remaining intra prediction modes. Alternatively, when the intra prediction mode of the current block is included in the MPM candidates, the encoding apparatus may not encode the MPM flag. That is, when the intra prediction mode of the current block is included in the MPM candidates, the intra prediction information may not include the MPM flag.

When the intra prediction mode of the current block is one of the remaining intra prediction modes, the encoding apparatus may encode the remaining intra prediction mode information for the current block. That is, when the intra prediction mode of the current block is one of the remaining intra prediction modes, the remaining intra prediction mode information may include the remaining intra prediction mode information. The remaining intra prediction mode information may indicate the intra prediction mode of the current block among the remaining intra prediction modes. Here, the remaining intra prediction modes may represent remaining intra prediction modes which are not included in the MPM candidates of the MPM list. The remaining intra prediction mode information may be signaled in the form of the rem_intra_luma_pred_mode or intra_luma_mpm_remainder syntax element.

For example, the remaining intra prediction mode information may be coded through a truncated binary (TB) binarization process. The binarization parameter for the TB binarization process may be preset. For example, the value of the binarization parameter may be 60 or 61. Alternatively, the value of the parameter may be set to a value acquired by subtracting the number of MPM candidates from the total number of intra prediction modes. Here, the binarization parameter may represent the cMax. The binarization parameter may indicate the maximum value of the remaining intra prediction mode information.

As described above, the remaining intra prediction mode information may be coded through the TB binarization process. Thus, when the value of the remaining intra prediction mode information is smaller than a specific value, the remaining intra prediction mode information may be binarized to a binary value of k bits. Further, when the value of the remaining intra prediction mode information is equal to or larger than a specific value, the remaining intra prediction mode information may be binarized to a binary value of k+1 bits. The specific value and the k may be derived based on the binarization parameter. For example, the specific value and the k may be derived based on Equation 3 described above. When the value of the binarization parameter is 61, the specific value may be derived as 3 and the k may be derived as 5.

Meanwhile, when the intra prediction mode of the current block is included in the MPM candidates, the encoding apparatus may encode the MPM index. That is, when the intra prediction mode of the current block is included in the MPM candidates, the intra prediction information of the current block may include the MPM index. The MPM index may indicate an MPM index indicating one of the MPM candidates of the MPM list. The MPM index may be signaled in the form of the mpm_idx or intra_luma_mpm_idx syntax element.

Meanwhile, for example, the MPM index may be binarized through the Truncated Rice (TR) binarization process. The binarization parameter for the TR binarization process may be preset. Alternatively, for example, the value of the binarization parameter may be set to a value obtained by subtracting 1 from the number of MPM candidates. When the number of MPM candidates is 6, the binarization parameter may be set to 5. Here, the binarization parameter may represent the cMax. The binarization parameter may indicate the maximum value of the MPM index. Further, cRiceParam for the TR binarization process may be preset to 0.

Further, the MPM index may be coded based on the context model.

In this case, for example, the context model for an n-th bin of the MPM index may be derived based on the n-th candidate included in the MPM list.

The context model for the N-th bin derived based on the N-th candidate may be as follows.

As an example, when the intra prediction mode indicated by the N-th MPM candidate is the DC intra prediction mode or the planar intra prediction mode, the context model for the N-th bin may be derived as context model 1, when the intra prediction mode indicated by the N-th MPM candidate is not the DC intra prediction mode and the planner intra prediction mode, but intra prediction modes #2 to #34, the context model for the N-th bin may be derived as context model 2, and when the intra prediction mode indicated by the N-th MPM candidate is not the DC intra prediction mode, the planar intra prediction mode, and intra prediction modes #2 to #34, but intra prediction modes #35 to #66, the context model for the N-th bin may be derived as context model 3.

Alternatively, as an example, when the intra prediction mode indicated by the N-th MPM candidate is the planar intra prediction mode, the context model for the N-th bin may be derived as context model 1, when the intra prediction mode indicated by the N-th MPM candidate is not the planar intra prediction mode but the DC intra prediction mode, the context model for the N-th bin may be derived as context model 2, when the intra prediction mode indicated by the N-th MPM candidate is not the planar intra prediction mode and the DC intra prediction mode, but intra prediction modes #2 to #34, the context model for the N-th bin may be derived as context model 3, and when the intra prediction mode indicated by the N-th MPM candidate is not the planar intra prediction mode, the DC intra prediction mode, and intra prediction modes #2 to #34, but intra prediction modes #35 to #66, the context model for the N-th bin may be derived as context model 4.

Meanwhile, as an example, the encoding apparatus may derive a residual sample for the current block based on an original sample and a prediction sample for the current block, generate information on the residual for the current block based on the residual sample, and encode the information on the residual. The video information may include the information on the residual.

Meanwhile, the bitstream may be transmitted to the decoding apparatus via a network or a (digital) storage medium. Here, the network may include a broadcasting network and/or a communication network and the digital storage medium may include various storage media including USB, SD, CD, DVD, Blu-ray, HDD, SSD, and the like.

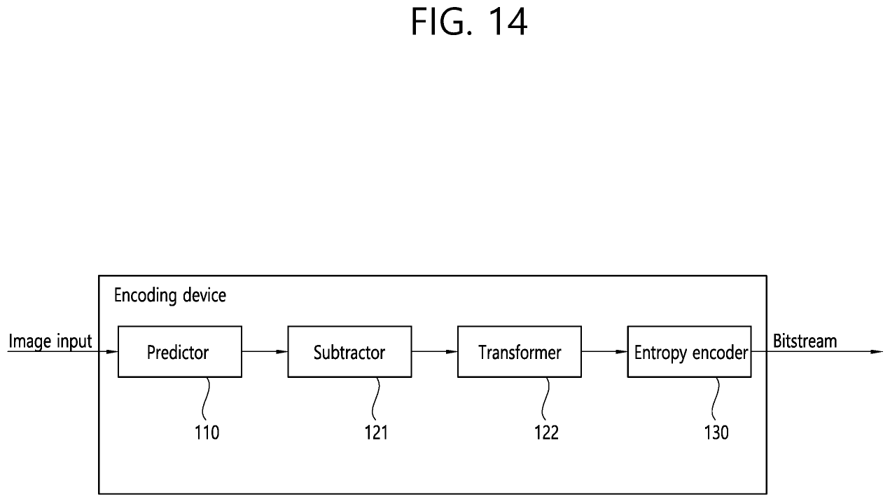

FIG. 14 schematically illustrates an encoding apparatus performing a video encoding method according to the present disclosure. The method disclosed in FIG. 13 may be performed by the encoding apparatus disclosed in FIG. 14. Specifically, for example, the prediction unit of the encoding apparatus of FIG. 14 may perform S1300 to S1320 of FIG. 13 and the entropy encoding unit of the encoding apparatus of FIG. 14 may perform S1330 of FIG. 13. In addition, although not illustrated, a process of deriving the residual sample for the current block based on an original sample and a prediction sample for the current block may be performed by a subtraction unit of the encoding apparatus of FIG. 14 and a process of generating information on the residual for the current block may be performed by a converter of the encoding apparatus of FIG. 14 and a process of encoding the information on the residual may be performed by an entropy encoder of the encoding apparatus of FIG. 14.

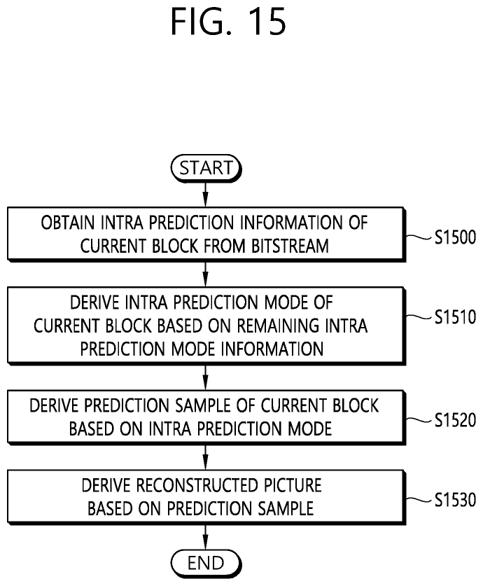

FIG. 15 schematically illustrates a video decoding method by a decoding apparatus according to the present disclosure. The method disclosed in FIG. 15 may be performed by the decoding apparatus disclosed in FIG. 3. Specifically, for example, S1500 of FIG. 15 may be performed by the entropy decoding unit of the decoding apparatus and S1510 to S1530 may be performed by the prediction unit of the decoding apparatus. In addition, although not illustrated, a process of obtaining information on prediction and/or information on the residual of the current block through the bitstream may be performed by the entropy decoding unit of the decoding apparatus, a process of deriving the residual sample for the current block based on the residual information may be performed by an inverse transform unit of the decoding apparatus, and a process of generating a reconstructed picture based on the prediction sample and the residual sample of the current block may be performed by an addition unit of the decoding apparatus.

The decoding apparatus acquires the intra prediction information of the current block from the bitstream (S1500). The decoding apparatus may obtain video information including the intra prediction information of the current block from the bitstream.

The intra prediction information may include a Most Probable Mode (MPM) flag for the current block. When the value of the MPM flag is 1, the decoding apparatus may obtain the MPM index for the current block from the bitstream. That is, when the value of the MPM flag is 1, the intra prediction information of the current block may include the MPM index. Alternatively, the intra prediction information may not include the MPM flag, and in this case, the decoding apparatus may derive the value of the MPM flag as 1. The MPM index may indicate an MPM index indicating one of the MPM candidates of the MPM list. The MPM index may be signaled in the form of the mpm_idx or intra_luma_mpm_idx syntax element.

When the value of the MPM flag is 0, the decoding apparatus may obtain the remaining intra prediction mode information for the current block from the bitstream. When the value of the MPM flag is 0, the remaining intra prediction information may include remaining intra prediction mode information indicating one of the remaining intra prediction modes. In this case, the decoding apparatus may derive the intra prediction mode indicated by the remaining intra prediction mode information among the remaining intra prediction modes as the intra prediction mode for the current block. Here, the remaining intra prediction modes may represent remaining intra prediction modes which are not included in the MPM candidates of the MPM list. The remaining intra prediction mode information may be signaled in the form of the rem_intra_luma_pred_mode or intra_luma_mpm_remainder syntax element.

For example, the remaining intra prediction mode information may be coded through a truncated binary (TB) binarization process. The binarization parameter for the TB binarization process may be preset. For example, the value of the binarization parameter may be 60 or 61. Alternatively, the value of the parameter may be set to a value acquired by subtracting the number of MPM candidates from the total number of intra prediction modes. Here, the binarization parameter may represent the cMax. The binarization parameter may indicate the maximum value of the remaining intra prediction mode information.

As described above, the remaining intra prediction mode information may be coded through the TB binarization process. Thus, when the value of the remaining intra prediction mode information is smaller than a specific value, the remaining intra prediction mode information may be binarized to a binary value of k bits. Further, when the value of the remaining intra prediction mode information is equal to or larger than a specific value, the remaining intra prediction mode information may be binarized to a binary value of k+1 bits. The specific value and the k may be derived based on the binarization parameter. For example, the specific value and the k may be derived based on Equation 3 described above. When the value of the binarization parameter is 61, the specific value may be derived as 3 and the k may be derived as 5.

Meanwhile, the MPM index may be coded through the Truncated Rice (TR) binarization process. The binarization parameter for the TR binarization process may be preset. Alternatively, for example, the value of the binarization parameter may be set to a value obtained by subtracting 1 from the number of MPM candidates. When the number of MPM candidates is 6, the binarization parameter may be set to 5. Here, the binarization parameter may represent the cMax. The binarization parameter may indicate the maximum value of the coded MPM index. Further, cRiceParam for the TR binarization process may be preset to 0.

Further, the MPM index may be coded based on the context model.

In this case, for example, the context model for an n-th bin of the MPM index may be derived based on the n-th candidate included in the MPM list.

The context model for the N-th bin derived based on the N-th candidate may be as follows.

As an example, when the intra prediction mode indicated by the N-th MPM candidate is the DC intra prediction mode or the planar intra prediction mode, the context model for the N-th bin may be derived as context model 1, when the intra prediction mode indicated by the N-th MPM candidate is not the DC intra prediction mode and the planner intra prediction mode, but intra prediction modes #2 to #34, the context model for the N-th bin may be derived as context model 2, and when the intra prediction mode indicated by the N-th MPM candidate is not the DC intra prediction mode, the planar intra prediction mode, and intra prediction modes #2 to #34, but intra prediction modes #35 to #66, the context model for the N-th bin may be derived as context model 3.

Alternatively, as an example, when the intra prediction mode indicated by the N-th MPM candidate is the planar intra prediction mode, the context model for the N-th bin may be derived as context model 1, when the intra prediction mode indicated by the N-th MPM candidate is not the planar intra prediction mode but the DC intra prediction mode, the context model for the N-th bin may be derived as context model 2, when the intra prediction mode indicated by the N-th MPM candidate is not the planar intra prediction mode and the DC intra prediction mode, but intra prediction modes #2 to #34, the context model for the N-th bin may be derived as context model 3, and when the intra prediction mode indicated by the N-th MPM candidate is not the planar intra prediction mode, the DC intra prediction mode, and intra prediction modes #2 to #34, but intra prediction modes #35 to #66, the context model for the N-th bin may be derived as context model 4.

Meanwhile, the decoding apparatus may construct the Most Probable Mode (MPM) list of the current block based on the neighboring block of the current block. Here, as an example, the MPM list may include three MPM candidates, five MPM candidates, or six MPM candidates.

For example, the decoding apparatus may construct the MPM list of the current block based on the neighboring block of the current block and the MPM list may include six MPM candidates. The neighboring block may include the left neighboring block, the upper neighboring block, the lower left neighboring block, the up-right neighboring block, and/or the up-left neighboring block of the current block. The decoding apparatus may search the neighboring blocks of the current block in a specific order and derive the intra prediction mode of the neighboring block as the MPM candidate in the derived order. For example, the decoding apparatus may derive the MPM candidate and the construct the MPM list of the current block by performing the search in the order of the intra prediction mode of the left neighboring block, the intra prediction mode of the upper neighboring block, the planner intra prediction mode, the DC intra prediction mode, the intra prediction mode of the lower left neighboring block, the intra prediction mode of the right upper neighboring block, and the intra prediction mode of the up-left neighboring block. Meanwhile, when six MPM candidates are not derived after the search, the MPM candidate may be derived based on the intra prediction mode derived as the MPM candidate. For example, when the intra prediction mode derived as the MPM candidate is intra prediction mode # N, the decoding apparatus may derive the intra prediction mode # N+1 and/or intra prediction mode # N−1 as the MPM candidate of the current block.

The decoding apparatus derives the intra prediction mode of the current block based on the intra prediction mode information (S1510). The decoding apparatus may derive the intra prediction mode indicating the remaining intra prediction mode information as the intra prediction mode of the current block. The remaining intra prediction mode information may indicate one of the remaining intra prediction modes. The remaining intra prediction modes may be intra prediction modes except for the MPM candidates from all intra prediction modes.

Meanwhile, as an example, when the value of the remaining intra prediction mode information is N, the remaining intra prediction mode information may indicate intra prediction mode # N.

Further, as another example, when the value of the remaining intra prediction mode information is N, the remaining intra prediction mode information may indicate N+1-th intra prediction mode in an intra mode map. The intra mode map may indicate intra prediction modes except for the MPM candidates from the intra prediction modes in a preset order. For example, the intra prediction modes in the preset order may be as follows.

{0, 1, 50, 18, 49, 10, 12, 19, 11, 34, 2, 17, 54, 33, 46, 51, 35, 15, 13, 45, 22, 14, 66, 21, 47, 48, 23, 53, 58, 16, 42, 20, 24, 44, 26, 43, 55, 52, 37, 29, 39, 41, 25, 9, 38, 56, 30, 36, 32, 28, 62, 27, 40, 8, 3, 7, 57, 6, 31, 4, 65, 64, 5, 59, 60, 61, 63}

Further, as another example, when the value of the remaining intra prediction mode information is N, the remaining intra prediction mode information may indicate intra prediction mode # N+1 in a TBC list. The TBC list may be constituted by intra prediction modes derived based on a directional intra prediction mode and an offset among the MPM candidates.

Meanwhile, when the value of the MPM flag is 1, the decoding apparatus may obtain the MPM index for the current block from the bitstream and derive the intra prediction mode of the current block based on the MPM index. The decoding apparatus may derive the MPM candidate indicated by the MPM index as the intra prediction mode of the current block. The MPM index may indicate one of the MPM candidates of the MPM list.

The decoding apparatus derives the prediction sample of the current block based on the intra prediction mode (S1620). The decoding apparatus may derive at least one neighboring sample among the neighboring samples of the current block based on the intra prediction mode and generate the prediction sample based on the neighboring sample. The neighboring samples may include upper left corner neighboring samples, an upper left neighboring sample, upper neighboring samples, and left neighboring samples of the current block. For example, when the size of the current block is W×H and an x component of a top-left sample position of the current block is 0 and a y component is 0, the left neighboring samples may be p[−1][0] to p−[1][2H−1], the upper left corner neighboring sample may be p[−1][4], and the upper neighboring samples may be p[0][−1] to p[2W−1][−1].

The decoding apparatus may generate the reconstructed picture based on the prediction sample (S1530). The decoding apparatus may directly use the prediction sample as a reconstructed sample or generate the reconstructed sample by adding the residual sample to the prediction sample. When there is the residual sample for the current block, the decoding apparatus may receive information on the residual for the current block and the information on the residual may be included in the information on the face. The information on the residual may include transform coefficients relating to the residual samples. The video information may include the information on the residual. The decoding apparatus may derive the residual sample (or residual sample array) for the current block based on the residual information. The decoding apparatus may generate the reconstructed sample based on the prediction sample and the residual sample and derive the reconstructed block or reconstructed picture based on the reconstructed sample.

Meanwhile, as described above, the decoding apparatus may apply an in-loop filtering procedure such as a deblocking filtering and/or SAO procedure to the reconstructed picture in order to enhance subjective/objective picture quality as necessary.

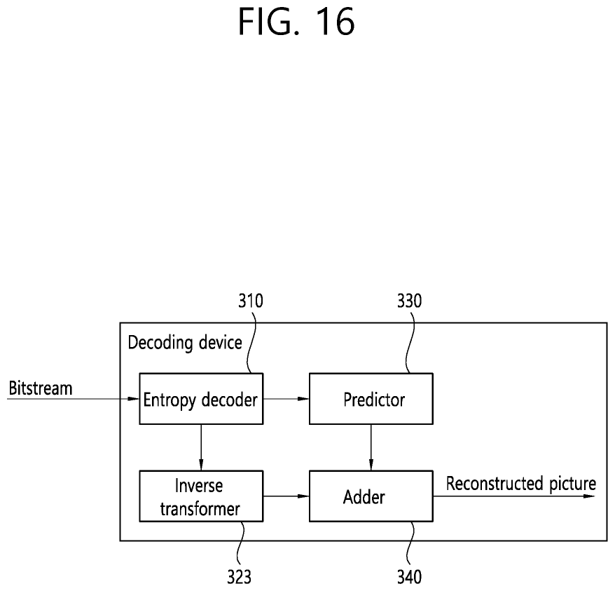

FIG. 16 schematically illustrates a decoding apparatus performing a video decoding method according to the present disclosure. The method disclosed in FIG. 15 may be performed by the decoding apparatus disclosed in FIG. 16. Specifically, for example, the entropy decoding unit of the decoding apparatus of FIG. 16 may perform S1500 of FIG. 15 and the prediction unit of the decoding apparatus of FIG. 16 may perform S1510 to S1530 of FIG. 15. In addition, although not illustrated, a process of obtaining video information including the information on the residual of the current block through the bitstream may be performed by the entropy decoding unit of the decoding apparatus of FIG. 16, a process of deriving the residual sample for the current block based on the information on the residual may be performed by the inverse transform unit of the decoding apparatus of FIG. 16, and a process of generating the reconstructed picture based on the prediction sample and the residual sample may be performed by the addition unit of the decoding apparatus of FIG. 16.

According to the present disclosure described above, intra prediction information can be coded based on a truncated binary code, which is a variable binary code, thereby reducing signaling overhead of intra prediction information for representing an intra prediction mode and enhancing overall coding efficiency.

Further, according to the present disclosure, a highly selectable intra prediction mode can be represented as information of a value corresponding to a small bit binary code, thereby reducing signaling overhead of intra prediction information and enhancing overall coding efficiency.

In the aforementioned embodiment, methods have been described based on flowcharts as a series of steps or blocks, but the methods are not limited to the order of the steps of the present disclosure and any step may occur in a step or an order different from or simultaneously as the aforementioned step or order. Further, it can be appreciated by those skilled in the art that steps shown in the flowcharts are not exclusive and other steps may be included or one or more steps do not influence the scope of the present disclosure and may be deleted.

The embodiments described herein may be implemented and performed on a processor, a microprocessor, a controller, or a chip. For example, functional units illustrated in each drawing may be implemented and performed on a computer, the processor, the microprocessor, the controller, or the chip. In this case, information (e.g., information on instructions) or an algorithm for implementation may be stored in a digital storage medium.

In addition, the decoding apparatus and the encoding apparatus to which the present disclosure may be included in a multimedia broadcasting transmitting and receiving device, a mobile communication terminal, a home cinema video device, a digital cinema video device, a surveillance camera, a video chat device, a real time communication device such as video communication, a mobile streaming device, storage media, a camcorder, a video on demand (VoD) service providing device, an (Over the top) OTT video device, an Internet streaming service providing devices, a 3 dimensional (3D) video device, a video telephone video device, a transportation means terminal (e.g., a vehicle terminal, an airplane terminal, a ship terminal, etc.), and a medical video device, etc., and may be used to process a video signal or a data signal. For example, the Over the top (OTT) video device may include a game console, a Blu-ray player, an Internet access TV, a home theater system, a smartphone, a tablet PC, a digital video recorder (DVR), and the like.

In addition, a processing method to which the present disclosure is applied may be produced in the form of a program executed by the computer, and may be stored in a computer-readable recording medium. Multimedia data having a data structure according to the present disclosure may also be stored in the computer-readable recording medium. The computer-readable recording medium includes all types of storage devices and distribution storage devices storing computer-readable data. The computer-readable recording medium may include, for example, a Blu-ray disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media implemented in the form of a carrier wave (e.g., transmission over the Internet). Further, the bitstream generated by the encoding method may be stored in the computer-readable recording medium or transmitted through a wired/wireless communication network.

In addition, the embodiment of the present disclosure may be implemented as a computer program product by a program code, which may be performed on the computer by the embodiment of the present disclosure. The program code may be stored on a computer-readable carrier.

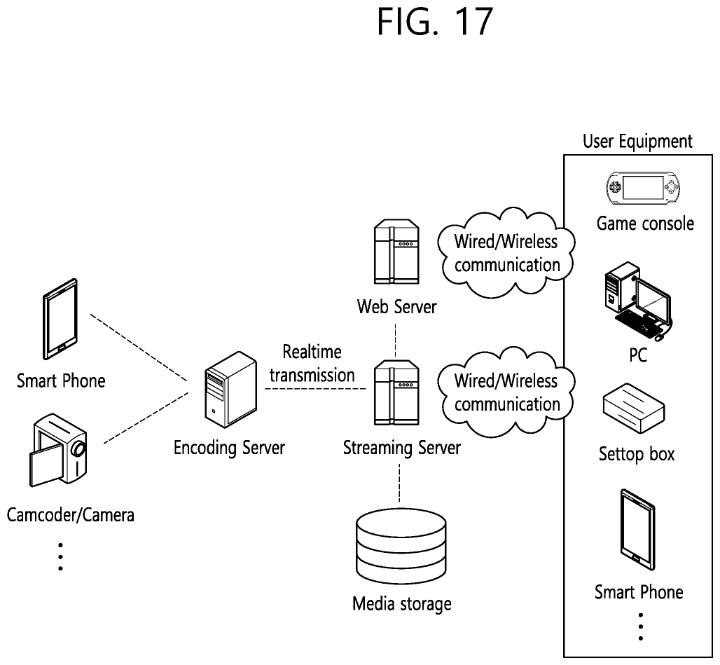

FIG. 17 exemplarily illustrates a structure diagram of a content streaming system to which the present disclosure is applied.

The content streaming system to which the present disclosure is applied may largely include an encoding server, a streaming server, a web server, a media storage, a user device, and a multimedia input device.

The encoding server compresses contents input from multimedia input devices including a smartphone, a camera, a camcorder, etc., into digital data to serve to generate the bitstream and transmit the bitstream to the streaming server. As another example, when the multimedia input devices including the smartphone, the camera, the camcorder, etc., directly generate the bitstream, the encoding server may be omitted.

The bitstream may be generated by the encoding method or the bitstream generating method to which the present disclosure is applied and the streaming server may temporarily store the bitstream in the process of transmitting or receiving the bitstream.

The streaming server transmits multimedia data to the user device based on a user request through a web server, and the web server serves as an intermediary for informing a user of what service there is. When the user requests a desired service to the web server, the web server transfers the requested service to the streaming server and the streaming server transmits the multimedia data to the user. In this case, the content streaming system may include a separate control server and in this case, the control server serves to control a command/response between respective devices in the content streaming system.

The streaming server may receive contents from the media storage and/or the encoding server. For example, when the streaming server receives the contents from the encoding server, the streaming server may receive the contents in real time. In this case, the streaming server may store the bitstream for a predetermined time in order to provide a smooth streaming service.

Examples of the user device may include a cellular phone, a smart phone, a laptop computer, a digital broadcasting terminal, a personal digital assistants (PDA), a portable multimedia player (PMP), a navigation, a slate PC, a tablet PC, an ultrabook, a wearable device such as a smartwatch, a smart glass, or a head mounted display (HMD), etc., and the like.

Each server in the content streaming system may be operated as a distributed server and in this case, data received by each server may be distributed and processed.

What is claimed is:

1. A video decoding method performed by a decoding apparatus, the method comprising:
obtaining intra prediction information of the current block through a bitstream;
deriving an intra prediction mode of the current block based on remaining intra prediction mode information;
deriving a prediction sample of the current block based on the intra prediction mode; and
deriving a reconstructed picture based on the prediction sample,
wherein the intra prediction information includes the remaining intra prediction mode information, and
wherein the remaining intra prediction mode information is coded through a truncated binary (TB) binarization process.

2. The video decoding method of claim 1, wherein when a value of the remaining intra prediction mode information is smaller than a specific value, the remaining intra prediction mode information is binarized to a binary value of k bits, and
wherein when the value of the remaining intra prediction mode information is larger than or equal to the specific value, the remaining intra prediction mode information is binarized to a binary value of k+1 bits.

3. The video decoding method of claim 2, wherein the specific value and the k are derived based on a binarization parameter for the TB binarization process.

4. The video decoding method of claim 3, wherein the specific value and the k are derived based on an equation below,
n=c Max+1
k=Floor(Log 2(n)) so that 2^{k}<=n<2^{k+1}
u=2^{k+1}n
where cMax represents the binarization parameter and u represents the specific value.

5. The video decoding method of claim 4, wherein the binarization parameter is set to a value acquired by subtracting the number of MPM candidates from the total number of intra prediction modes.

6. The video decoding method of claim 1, wherein the intra prediction mode indicated by the remaining intra prediction mode information is derived as the intra prediction mode of the current block,
wherein the remaining intra prediction mode information indicates one of remaining intra prediction modes, and
wherein the remaining intra prediction modes represent intra prediction modes except for Most Probable Mode (MPM) candidates of the current block from all intra prediction modes.

7. The video decoding method of claim 6, wherein when the value of the remaining intra prediction mode information is N, the remaining intra prediction mode information indicates an N+1-th intra prediction mode in an intra mode map.

8. The video decoding method of claim 7, wherein the intra mode map indicates intra prediction modes except for the MPM candidates from the intra prediction modes in a preset order.

9. The video decoding method of claim 8, wherein the intra prediction modes in the preset order are as follows.
{0, 1, 50, 18, 49, 10, 12, 19, 11, 34, 2, 17, 54, 33, 46, 51, 35, 15, 13, 45, 22, 14, 66, 21, 47, 48, 23, 53, 58, 16, 42, 20, 24, 44, 26, 43, 55, 52, 37, 29, 39, 41, 25, 9, 38, 56, 30, 36, 32, 28, 62, 27, 40, 8, 3, 7, 57, 6, 31, 4, 65, 64, 5, 59, 60, 61, 63}

10. A video encoding method performed by an encoding apparatus, the method comprising:
constructing a Most Probable Mode (MPM) list of a current block based on a neighboring block of the current block;
determining an intra prediction mode of the current block, wherein the intra prediction mode of the current block is one of remaining intra prediction modes;
generating a prediction sample of the current block based on the intra prediction mode; and
encoding video information including intra prediction information for the current block,
wherein the remaining intra prediction modes are intra prediction modes except for MPM candidates included in the MPM list from all intra prediction modes,
wherein the intra prediction information includes remaining intra prediction mode information,
wherein the remaining intra prediction mode information indicates the intra prediction mode of the current block among the remaining intra prediction modes, and
wherein the remaining intra prediction mode information is coded through a truncated binary (TB) binarization process.

11. The video encoding method of claim 10, wherein when a value of the remaining intra prediction mode information is smaller than a specific value, the remaining intra prediction mode information is binarized to a binary value of k bits, and
wherein when the value of the remaining intra prediction mode information is larger than or equal to the specific value, the remaining intra prediction mode information is binarized to a binary value of k+1 bits.

12. The video encoding method of claim 11, wherein the specific value and the k are derived based on a binarization parameter for the TB binarization process.

13. The video encoding method of claim 12, wherein the specific value and the k are derived based on an equation below,
n=c Max+1
k=Floor(Log 2(n)) so that 2^{k}<=n<2^{k+1}
u=2^{k+1}n
where cMax represents the binarization parameter and u represents the specific value.

14. The video encoding method of claim 13, wherein the binarization parameter is set to a value acquired by subtracting the number of MPM candidates from the total number of intra prediction modes.

15. The video encoding method of claim 10, wherein when the value of the remaining intra prediction mode information is N, the remaining intra prediction mode information indicates an N+1-th intra prediction mode in an intra mode map.
